(19) United States
(12) Patent Application Publication
(10) Pub. No.: US 2014/0351063 A1
(43) Pub. Date: Nov. 27, 2014

(54) MARKETING CAMPAIGN DEVELOPMENT AND MANAGEMENT

(71) Applicants: John Brewer, Malvern, PA (US); Salma Khan, Norristown, PA (US)

(72) Inventors: John Brewer, Malvern, PA (US); Salma Khan, Norristown, PA (US)

(73) Assignee: RICOH COMPANY, LTD., Tokyo (JP)

(21) Appl. No.: 13/900,132

(22) Filed: May 22, 2013

(51) Int. Cl. G06Q 30/02

(52) U.S. Cl. CPC G06Q 30/0276
USPC 705/14.72

(57) ABSTRACT

Apparatuses, systems and methods are provided for assisting a user to manage, and create materials for, a marketing campaign or event. A graphical user interface (GUI) is provided for the user to create a new campaign or event as well as to manage existing campaigns or events.

### TECHNICAL FIELD

This disclosure relates to systems, apparatuses and methodologies for managing and developing marketing campaigns and events, including providing a graphical user interface (GUI) for a user to manage campaigns and events.

### BACKGROUND

In the current information age, use of information technology (IT) tools proliferate in all walks of life, including managing and generating information and data in business and industry. For example, various content authoring software are available to allow a user to generate information or content (such as marketing materials, e.g., marketing flyers, pamphlets, etc., for a particular marketing event) for a targeted audience. Other IT tools may be employed to facilitate distribution of the marketing materials by e-mail or mail to the targeted audience. In the typical instance in marketing, the user must mentally and manually manage the collection and flow of marketing information, even if software tools are used by the user to assist with generation and transmission of the marketing materials and other content. That is, the user typically needs to use one software tool to generate text, another to generate graphical elements to be inserted in the material, yet another to compose the various information elements into a single presentation, another to create or assemble a distribution list using another software, etc. Further, such the marketing materials typically requires supervisory approval before distribution to the targeted audience, the user provide the marketing materials electronically and/or in hardcopy form to the supervisor, and then distribute the marketing material upon approval by the supervisor. However, a marketing professional who is familiar with a conventional process of putting together marketing material would appreciate that there are many more steps that must be performed manually and/or mentally, in such process.

Such process is cumbersome, even if software tools are available, since each software has its own interface and format, and the user must operate multiple interfaces and act as the integrator of the multiple tools.

### SUMMARY

This disclosure describes various tools (for example, a system, an apparatus, application software, etc.) which are user-friendly and can be provided to assist a user to manage, and put together materials for, marketing campaigns or events.

In an aspect of this disclosure, a marketing connection application is provided on a user terminal and the marketing connection application provides an event campaign GUI (graphical user interface) interface that takes the user through the various steps of coordinating, and putting together the materials for, a marketing campaign and/or event. For example, the GUI includes a campaign/event creation and development part through which the user specifies a marketing object to be created for a specified/selected marketing campaign or event, and specifies details specific to the marketing campaign or event to populate the marketing object for the marketing campaign or event. Further, the GUI includes a guest list access part that allows a list of guests and invitees for a marketing event to be maintained (e.g., created, downloaded and registered, edited, etc.), and provides the list, upon request by the user, for user edit of the list of guests and invitees. In addition, the GUI includes a customizing materials GUI interface to allow the user to select a marketing template and populate the selected marketing template with campaign/event information maintained in the marketing object, for user selection of already-generated materials, for user modification of the populated marketing template and/or already-generated materials to form customized marketing materials for the selected marketing campaign or event, and for causing the customized marketing materials to be maintained in association with the marketing object for the specified/selected marketing campaign or event. Further, the GUI includes a review information GUI interface for allowing the user to edit one or more of the campaign/event-specific details, customized marketing materials and other associated information, for the marketing campaign or event. In addition, an event submission part submits the marketing object, associated campaign/event-specific details, customized marketing materials and other associated information, for the marketing campaign or event, for approval by an event administrator.

In another aspect, the marketing connection application can include a theme selection part for user selection of a theme or one or more of a theme-specific image and a theme-specific graphical element. In a case that the user selects a theme, one or more of an image and a graphical element specific to the selected theme are applied to the customized materials. In a case that the user selects a theme-specific image or theme-specific graphical element, the user-selected theme-specific image or graphical element is applied to the customized materials.

In another aspect, the marketing connection application can include a preview part that permits the user to request preview of a specified item amongst the customized marketing materials.

In another aspect, the marketing connection application can provide one or more event templates for user selection. In a case that the user selects an event template, the event creation and development part populates the event template with user-specified event-specific details specific to the marketing event, and generates the marketing object based on the populated event template.

In another aspect, the marketing connection application can further provide an event agenda access part to create and maintain an event agenda for the selected marketing event, and provide the event agenda, upon request by the user, for modification.

In another aspect, the marketing connection application can further provide a registration customization interface through which the user customizes information fields of a registration GUI interface to be provided at a registration page.

In another aspect, the marketing connection application can configure the user terminal to include a response review interface for providing, upon user request, a summary of responses to an invitation to the marketing event, wherein the response review interface includes a filter for filtering the response summary according to one or more filter criteria selected from a group including a date range, an alphabetized name range, a company name, an alphabetized e-mail address range, and an e-mail address domain.

In another aspect, the marketing connection application can configure the user terminal to include an e-mail marketing interface for compiling an event marketing e-mail, including selecting a marketing e-mail type or template, formulating a distribution list, and one or more of the customized materials to be included in the event marketing e-mail for the marketing event, and scheduling e-mail transmission date-and-time. The e-mail marketing interface can be configured to automatically generate the event marketing e-mail based on the selected marketing e-mail type or template and the selected materials. Further, the marketing connection application can include a preview part that permits the user to request preview of the event marketing e-mail. In addition, the e-mail marketing interface can permit the user to retrieve and modify the event marketing e-mail, before the scheduled transmission date-and-time. Further, the marketing connection application can include a response review interface for providing, upon user request, a summary of responses to the event marketing e-mail. The response review interface may include a filter for filtering the response summary according to one or more filter criteria selected from a group including a date range, an alphabetized name range, a company name, an alphabetized e-mail address range, and an e-mail address domain.

In another aspect, the marketing connection application can configure the user terminal to include a landing page development interface to develop an event landing page, based on at least a selected landing page template and one or more selected items from amongst the customized materials, and to further customize content on the event landing page. The landing page development interface may further include a registration customization interface through which the user customizes information fields of a registration GUI interface to be provided through the event landing page. Further, the marketing connection application may include a response review interface for providing, upon user request, a summary of responses received through the event landing page, the response review interface including a filter for filtering the response summary according to one or more filter criteria selected from a group including a date range, an alphabetized name range, a company name, an alphabetized e-mail address range, and an e-mail address domain.

In another aspect, the marketing connection application configures the user terminal to include a social media interface to develop a posting, based on at least a selected social media template and one or more selected items from amongst the customized materials, and to further customize content on the social media posting. The social media interface may include a registration customization interface through which the user customizes information fields of a registration GUI interface to be provided through the social media posting. Further, the marketing connection application can include a response review interface for providing, upon user request, a summary of responses received through the social media posting, wherein the response review interface includes a filter for filtering the response summary according to one or more filter criteria selected from a group including a date range, an alphabetized name range, a company name, an alphabetized e-mail address range, and an e-mail address domain.

In another aspect, the marketing connection application can include an event selection GUI interface presented in a calendar view GUI for user selection of a marketing event from the various calendared events. For example, after user authentication based on user credentials entered by the user through a login interface, the GUI elements provided in the calendar view are selected by the event selection GUI interface based on the authenticated user credentials.

In another aspect of this disclosure, a web service providing apparatus provides a marketing connection application through a network to the user terminal, receives from the terminal event-specific details, customized marketing materials and other associated event-specific information, associated with the marketing object, for the marketing event, and forwards to a marketing database the data received from the terminal.

In another aspect of this disclosure, the marketing connection application configures the user terminal to be a marketing connection service client, to communicate through a network with a marketing connection service providing apparatus. The marketing connection service client provides the event selection GUI interface and the event campaign GUI interface, and communicates the event-specific details, customized marketing materials and other associated event-specific information, associated with the marketing object, for the marketing event, to the marketing connection service providing apparatus. In turn, the marketing connection service providing apparatus causes the event-specific details, customized marketing materials and other associated event-specific information, associated with the marketing object, for the marketing event, to be stored in a marketing database.

### BRIEF DESCRIPTION OF THE DRAWINGS

The aforementioned and other aspects, features and advantages can be more readily understood from the following detailed description with reference to the accompanying drawings wherein:

FIG. 1A shows a block diagram of a system for managing documents, according to an exemplary embodiment;

FIG. 1B shows a block diagram of a system for managing documents, according to another exemplary embodiment;

FIG. 2A shows a schematic view illustrating, at a high-level, a configuration of a marketing connection application that can be provided in either the system of FIG. 1A or the system of FIG. 1B;

FIG. 2B shows a schematic view of an events controller of the marketing connection application of FIG. 2A;

FIG. 2C shows a schematic view of an emails controller of the marketing connection application of FIG. 2A;

FIG. 2D shows a schematic view of a direct mails controller of the marketing connection application of FIG. 2A;

FIG. 2E shows a schematic view of a modified configuration of the marketing connection application to include a social media controller for an event campaign process;

FIG. 3 shows sample event information maintained in a marketing database, according to an exemplary embodiment;

FIG. 4 shows a block diagram of an exemplary configuration of a marketing connection service providing apparatus, such as illustrated in FIG. 1B, according to an exemplary embodiment;

FIG. 5 shows a block diagram of an exemplary configuration of a terminal, such as illustrated in FIG. 1A, according to an exemplary embodiment;

FIGS. 6A and 6B show sample screenshots of a user interface displayed to the user, according to an exemplary embodiment;

FIGS. 7A and 7B show sample screenshots of a graphical user interface display to the user, according to an exemplary embodiment;

FIGS. 7C and 7D show sample screenshots of a list of events, according to an exemplary embodiment;

FIG. 8 shows a diagram illustrating typical workflows within the marketing connection application of FIG. 2A;

FIGS. 9A-9H show sample screenshots of a graphical user interface for developing a new marketing event, according to an exemplary embodiment;

FIGS. 10A and 10B show sample screenshots of a graphical user interface for viewing a submitted marketing campaign, according to an exemplary embodiment;

FIGS. 11A-11E show sample screenshots of a graphical user interface for managing a list of attendees, according to an exemplary embodiment;

FIG. 12 shows a sample screenshot of a list of email campaigns, according to an exemplary embodiment;

FIGS. 13A-13F show sample screenshots of a graphical user interface for developing a new email campaign, according to an exemplary embodiment;

FIG. 14 shows a sample screenshot of a graphical user interface for viewing a submitted email campaign, according to an exemplary embodiment;

FIG. 15 shows a sample screenshot of a list of direct mail campaigns, according to an exemplary embodiment;

FIGS. 16A-16E show sample screenshots of a graphical user interface for developing a new direct mail campaign, according to an exemplary embodiment;

FIG. 17A shows a sample screenshot of a graphical user interface for viewing a submitted direct mail campaign, according to an exemplary embodiment;

FIG. 17B shows a sample screenshot of a graphical user interface for viewing approved direct mail campaigns, according to an exemplary embodiment;

FIG. 17C and FIG. 17D show sample screenshots of a graphical user interface for placing an order for promotional materials, according to an exemplary embodiment;

FIG. 18 shows a sample screenshot of a list of social media campaigns, according to an exemplary embodiment;

FIGS. 19A-19E show sample screenshots of a graphical user interface for developing a new social media campaign, according to an exemplary embodiment;

FIG. 20 shows a sample screenshot of a graphical user interface for viewing a submitted social media campaign, according to an exemplary embodiment;

FIGS. 21A-21D show sample screenshots of a graphical user interface for managing themes, according to an exemplary embodiment;

FIG. 22 shows a flow chart of a method for customizing campaign materials, according to an exemplary embodiment;

FIG. 23 shows a sample screenshot of a graphical user interface for viewing reports, according to an exemplary embodiment;

FIG. 24 shows a sample screenshot of a graphical user interface for viewing a list of email blasts, according to an exemplary embodiment;

FIG. 25A-25E show sample data corresponding to a selected email blast, according to an exemplary embodiment; and

FIG. 26 shows a sample screenshot of a graphical user interface for managing templates, according to an exemplary embodiment.

### DETAILED DESCRIPTION

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. In addition, a detailed description of known functions and configurations will be omitted when it may obscure the subject matter of the present invention.

In this disclosure, various tools are discussed for providing a marketing connection application to assist a user to manage, and put together materials for, marketing campaigns or events. It should be appreciated by those skilled in the art that a marketing connection application can be provided in any of various ways and thus while various examples are discussed herein, the inventive subject matter of this disclosure is not limited to such examples described herein.

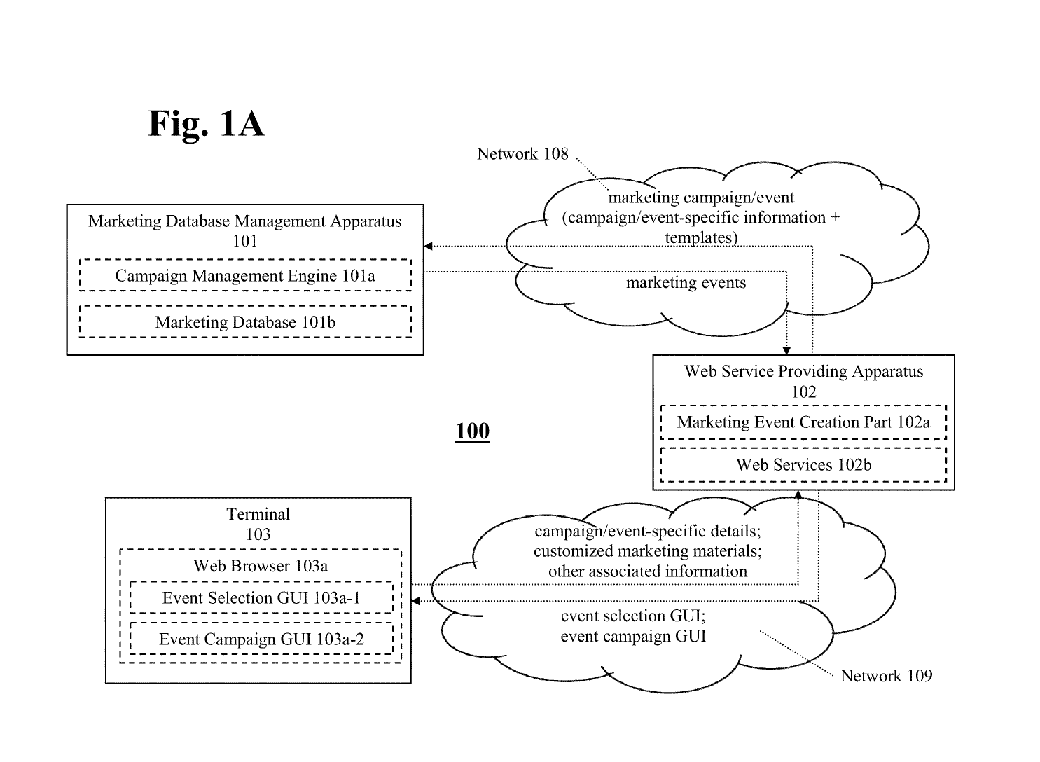

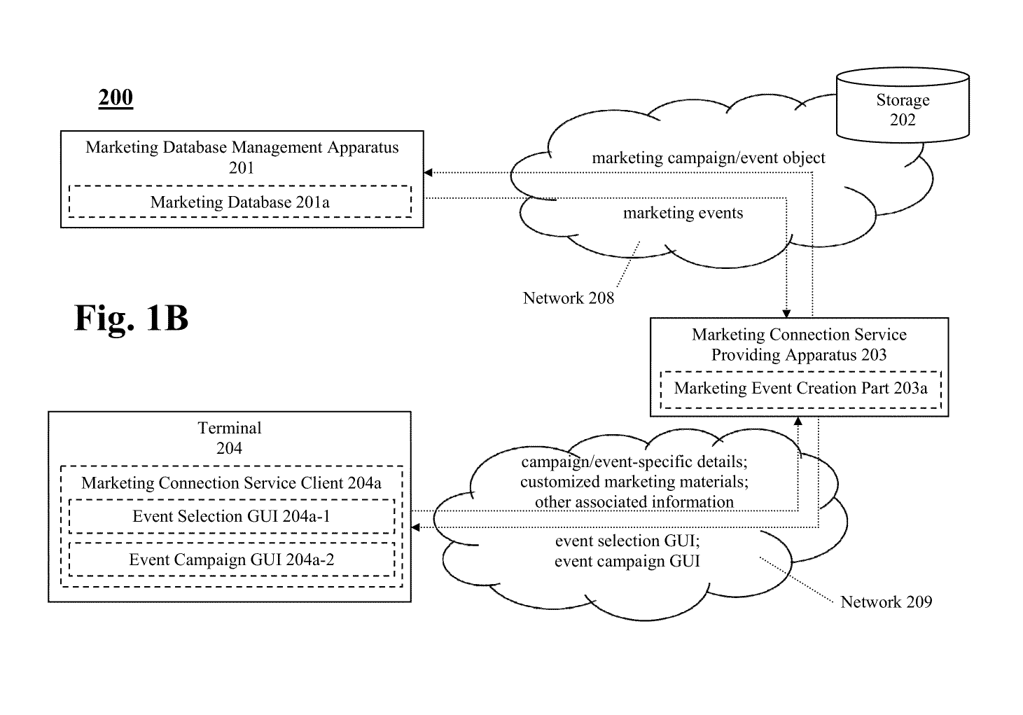

Referring now to the drawings, wherein like reference numerals designate identical or corresponding parts throughout the several views, FIG. 1A shows schematically a system 100 for developing and managing marketing events, according to an exemplary embodiment of this disclosure.

The system 100 includes a marketing database management apparatus 101, a web service providing apparatus 102 and a terminal 103. The marketing database management apparatus 101 and the web service providing apparatus 102 are interconnected by a network 108, and the web service providing apparatus 102 and the terminal 103 are interconnected by a network 109. In the system 100, a marketing connection application is provided as a web service to the terminal 103.

The marketing database management apparatus 101 includes a campaign management engine 101a and a marketing database 101b for storing marketing events and other data or information. The campaign management engine 101a causes new marketing events created by the user to be stored in the marketing database 101b. The campaign management engine 101a also causes any data or information (e.g. a list of marketing events created by the user) requested from the marketing database 101b to be transmitted to the web service providing apparatus 102, which further relays and causes the transmitted information to be displayed to the user at the terminal 103. The marketing database 101b can comprise one or more structural or functional parts that have or support a storage function. For example, the marketing database 101b can be, or can be a component of, a source of electronic data, such as a web server, a backend server connected to a web server, an e-mail server, a file server, a multi-function peripheral device (MFP or MFD), a voice data server, an application server, a computer, a network apparatus, a terminal etc.

The web service providing apparatus 102 includes a marketing event creation part 102a for creating a new cabinet in the marketing database 101b, and web services 102b for providing various services to users of the system 100, such as creating or deleting marketing events for a user, retrieving contents from the marketing database 101b, uploading or downloading files and other data to be used in connection with developing and managing marketing events, and etc. Such web services may also allow creating or modifying users, groups, templates for customizing marketing events, and etc.

The web service providing apparatus 102 can be configured in software or hosted on any computing device, including but not limited to a personal, notebook or workstation computer, a kiosk, a PDA (personal digital assistant), a MFD, a server, a mobile phone or handset, another information terminal, etc., that can communicate through the networks 108 and 109 with other devices.

The web service providing apparatus 102 of this disclosure may be realized by a computer program product including a computer-usable, non-transient medium (such as a disk storage apparatus) having instructions embodied therein that are executed by a computer. Thus, it should be understood that the web service providing apparatus 102 may be executed on a computer. While the web service providing apparatus 102 is shown as being external to the terminal 103, the web service providing apparatus 102 may in fact be executed on the terminal 103.

As shown in FIG. 1A, the web service providing apparatus 102 can provide an event selection GUI 103a-1 and an event campaign GUI 103a-2 via a web browser 103a running on the terminal 103. The event selection GUI (graphical user interface) 103a-1 provides one or more GUI elements for user selection of a marketing event. For example, a marketing event is an open house in which a company showcases its technology and business solutions provided to its customers. However, the marketing event discussed in the present disclosure is not limited to such an open house, and may include any kind of event in which guests are invited and for which customized materials may be desired. The marketing event creation part 102 may retrieve a list of marketing events from the marketing database 101b of the marketing database management apparatus 101 and cause the list of marketing events to be displayed to the user at the terminal 103 via the event selection GUI 103a-1.

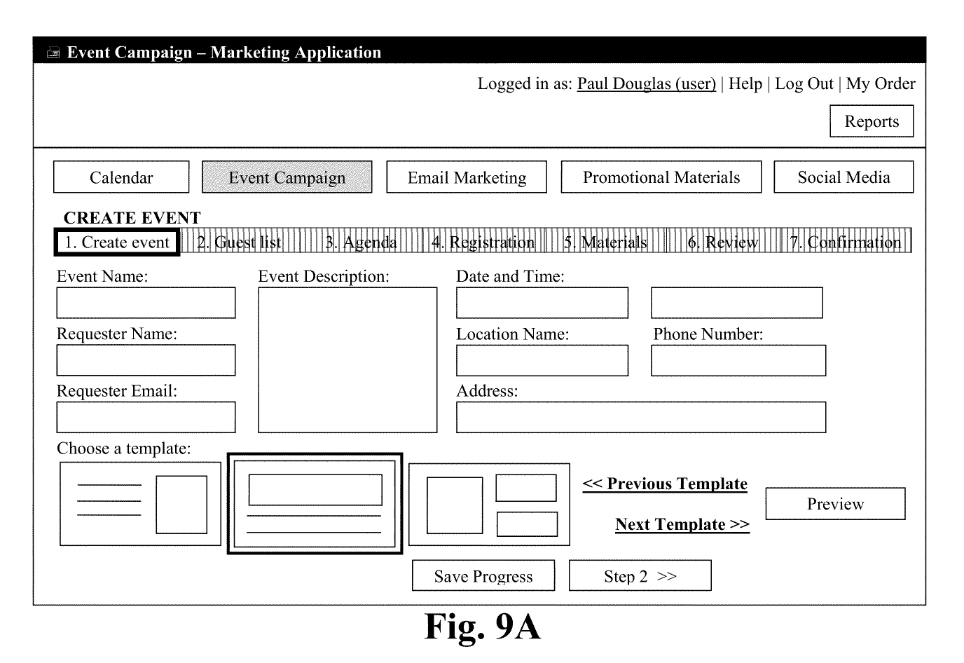

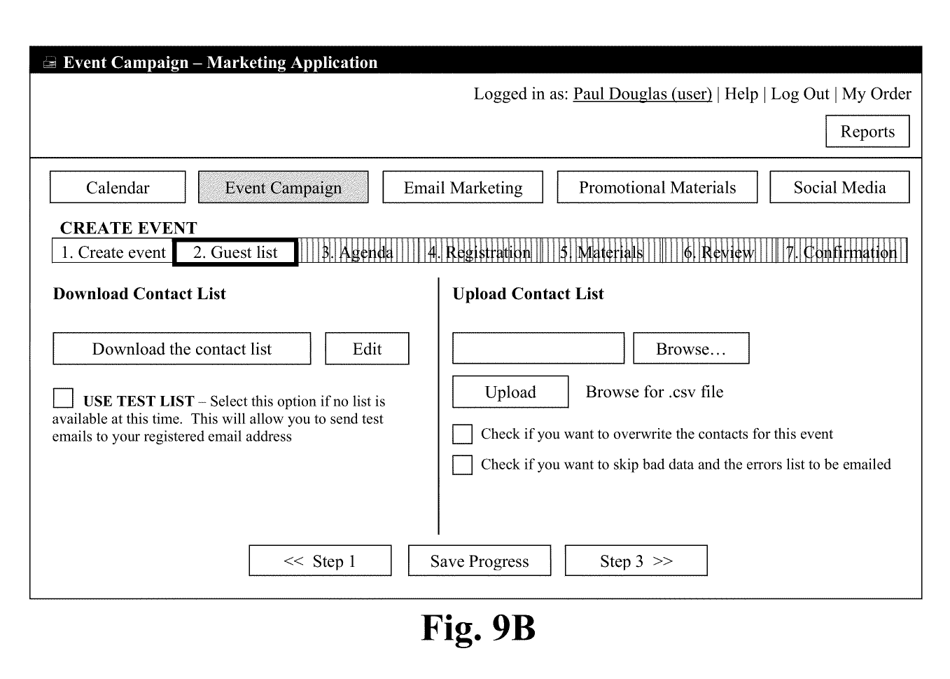

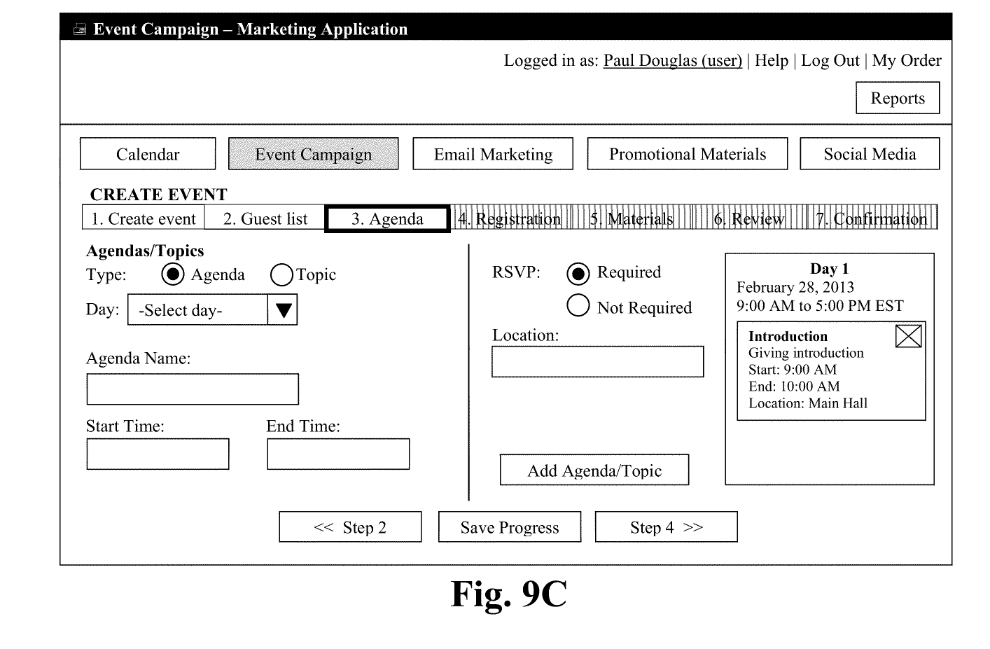

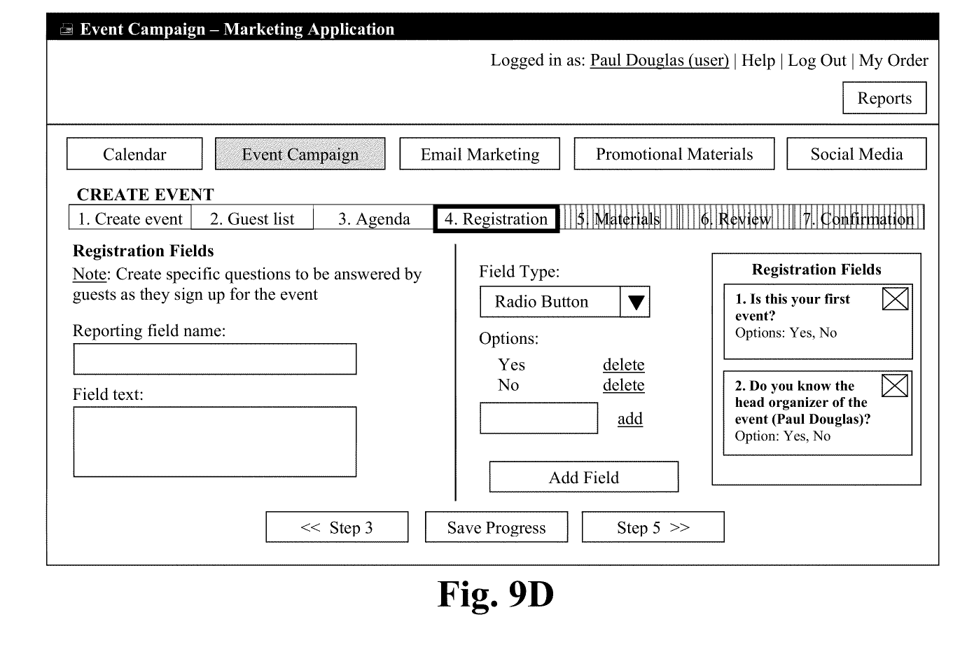

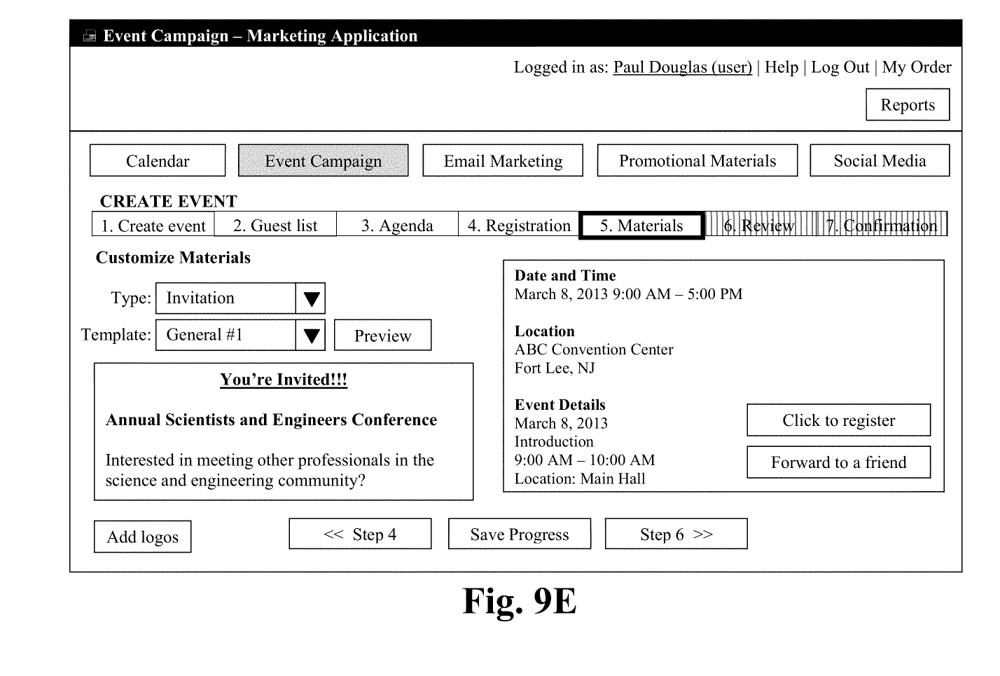

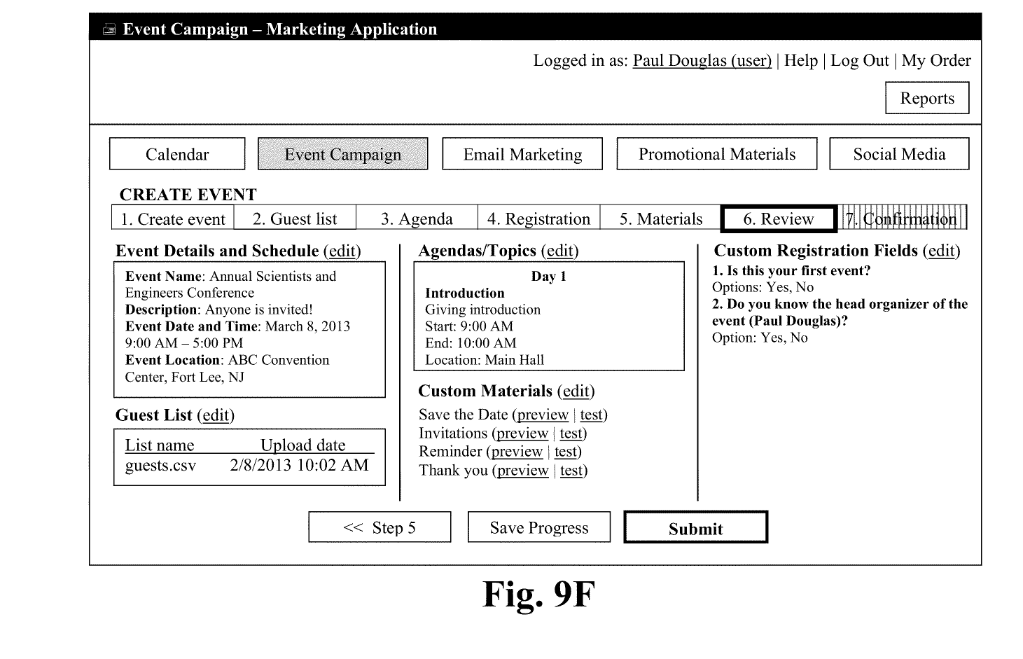

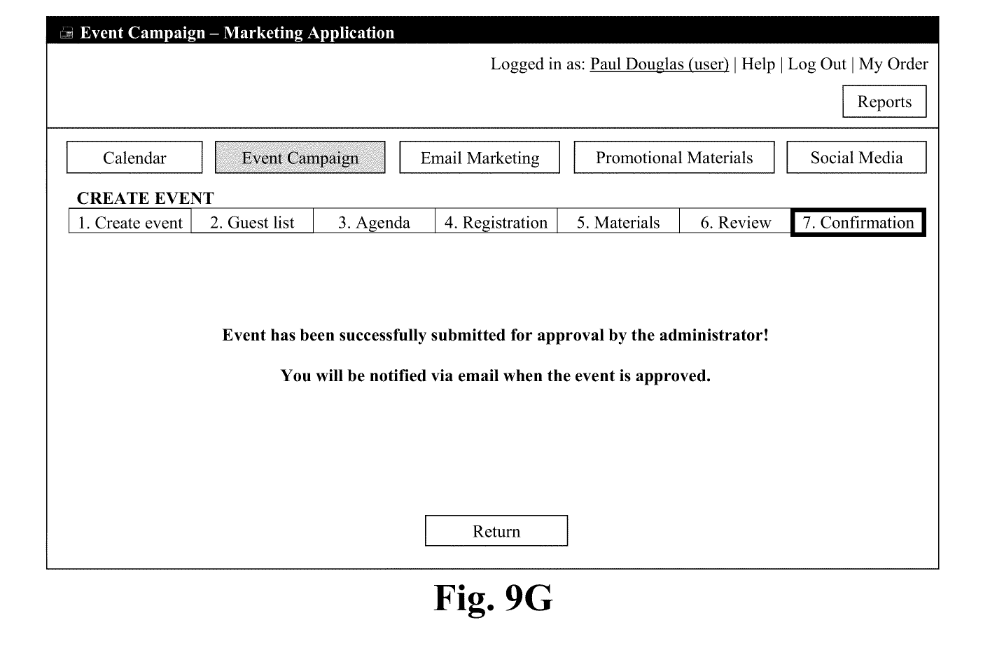

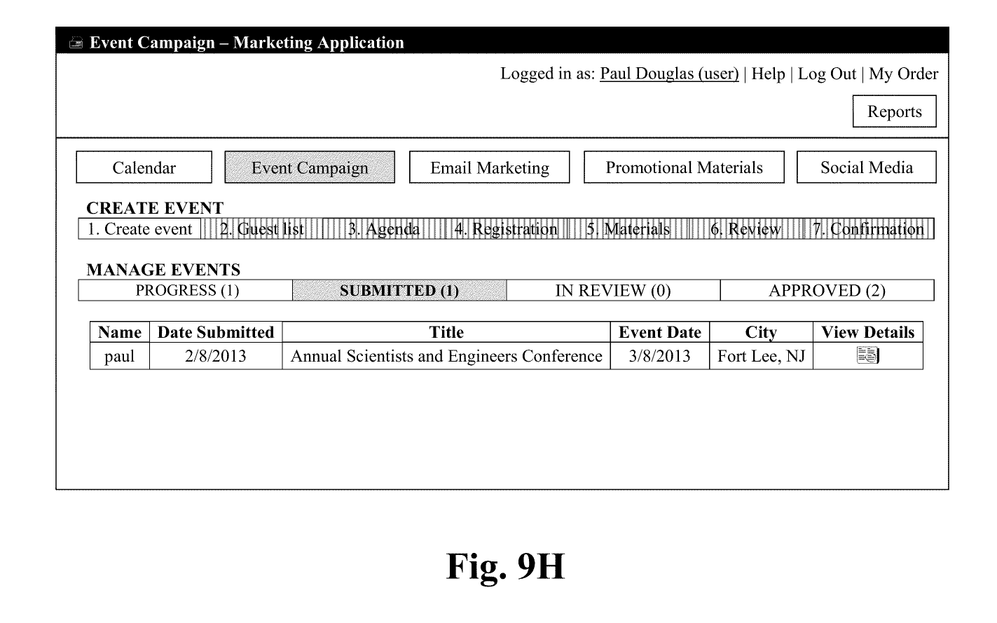

The event campaign GUI 103a-2 includes: (i) an event creation and development part through which the user specifies a marketing object to be created for the selected marketing event, and specifies event-specific details specific to the selected marketing event to populate the marketing object for the selected marketing event; (ii) a guest list access part maintaining a list of guests and invitees for the selected marketing event, and providing the list, upon request by the user, for user edit of the list of guests and invitees; (iii) a customizing materials GUI interface for allowing the user to select a marketing template and populating the selected marketing template with event information maintained in the marketing object, for user selection of already-generated materials, for user modification of the populated marketing template and/or already-generated materials to form customized marketing materials for the selected marketing event, and for causing the customized marketing materials to be maintained in association with the marketing object for the selected marketing event; (iv) a review event information GUI interface for allowing the user to edit one or more of the event-specific details, customized marketing materials and other associated event-specific information, for the marketing event; and (v) an event submission part that submits the marketing object, associated event-specific details, customized marketing materials and other associated event-specific information, for the marketing event, for approval by an event administrator. Each of the elements of the event campaign GUI 103a-2 is further described infra with reference to FIGS. 9A-9H.

The web services 102 include various user functionalities provided to users of the marketing campaign management system (e.g. system 100), including retrieving marketing objects from the marketing database 101b managed by the campaign management engine 101a, uploading files, data and other information to the marketing database 101b, etc. The web services 102 also include administrative functionalities such as creating and modifying users, groups, creating and modifying templates and themes to be used for creating marketing event campaigns, etc. For example, such functionalities can be utilized by using HTTP/HTTPS calls (e.g. from a web browser running on the terminal 103).

Each of the marketing database management apparatus 101, the web service providing apparatus 102 and the terminal 103 may include an internal storage unit therein and/or an external storage unit connected thereto, for storing various information and data generated or received via the networks 108 and 109.

The terminal 103 may include a processing unit and a display unit, where the processing unit executes an application (e.g. web browser 103a) to cause the display unit to display the user interfaces (e.g. event selection GUI 103a-1, event campaign GUI 103a-2, etc.) provided by the marketing event creation part 102a. The terminal 103 is further described infra with reference to FIG. 5.

It should be appreciated that while only the terminal 103 is shown in the example of FIG. 1A, the system 100 can include more terminals. Indeed, the document management system of this disclosure is preferably configured to be scalable such that terminals can be added to the system as desired and needed (e.g. to serve more users).

Each of the networks 108 and 109 can be a local area network, a wide area network or any type of network such as an intranet, an extranet (for example, to provide controlled access to external users, for example through the Internet), a private or public cloud network, the Internet, etc., or a combination thereof. Further, other communications links (such as a virtual private network, a wireless link, etc.) may be used as well for the network 109. In addition, each of the networks 108 and 109 preferably uses TCP/IP (Transmission Control Protocol/Internet Protocol), but other protocols such as SNMP (Simple Network Management Protocol) and HTTP (Hypertext Transfer Protocol) can also be used. How devices can connect to and communicate over networks is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference. Although the networks 108 and 109 are shown as two separate networks in the example of FIG. 1A, they may both be represented by a single network.

FIG. 1B shows schematically a system 200 for developing and managing marketing events, according to another exemplary embodiment of this disclosure. The system 200 includes a marketing database management apparatus 201 including a marking database 201a, a storage 202, a marketing connection service providing apparatus 203 including a marketing event creation part 203a and a terminal 204. The marketing database management apparatus 201, the storage 202 and the marketing connection service providing apparatus 203 are interconnected by a network 208, and the marketing connection service providing apparatus 203 and the terminal 204 are interconnected by a network 209.

In the system 200, the storage 202 connected to the network 208 is accessible by the marketing database management apparatus 201 and the marketing connection service providing apparatus 203, and any information or data generated or collected by the marketing database management apparatus 201 and the marketing connection service providing apparatus 203 (or a portion thereof) may be stored in the storage 202.

Further, the marketing connection service providing apparatus 203 provides to the terminal 204 a marketing connection service client 204a, and the marketing connection service providing apparatus 203 communicates with the marketing connection service client 204a to provide an event selection GUI 204a-1 and an event campaign GUI 204a-2 on the terminal 204.

The marketing connection service providing apparatus 203 can be configured in software or hosted on any computing device, including but not limited to a personal, notebook or workstation computer, a kiosk, a PDA (personal digital assistant), a MFD, a server, a mobile phone or handset, another information terminal, etc., that can communicate through the networks 208 and 209 with other devices.

The marketing connection service providing apparatus 203 of this disclosure may be realized by a computer program product including a computer-usable, non-transient medium (such as a disk storage apparatus) having instructions embodied therein that are executed by a computer. Thus, it should be understood that the marketing connection service providing apparatus 203 may be executed on a computer. While the marketing connection service providing apparatus 203 is shown as being external to the terminal 204, the marketing connection service providing apparatus 203 may in fact be executed on the terminal 204.

Also, as shown in FIG. 1B, the marketing connection service providing apparatus 203 forwards a new marketing object to be added to the marketing database 201a managed by the marketing database management apparatus 201. For example, such marketing object may be a single data structure containing all the information and data associated with the new marketing event, or may be a plurality of smaller objects linked together to represent a single marketing event.

Otherwise, operations of the elements of the system 200 are similar to those discussed in connection with the corresponding elements of the system 100 of FIG. 1A.

A marketing connection application that can be provided in the system of FIG. 1A or in the system of FIG. 1B will now be discussed.

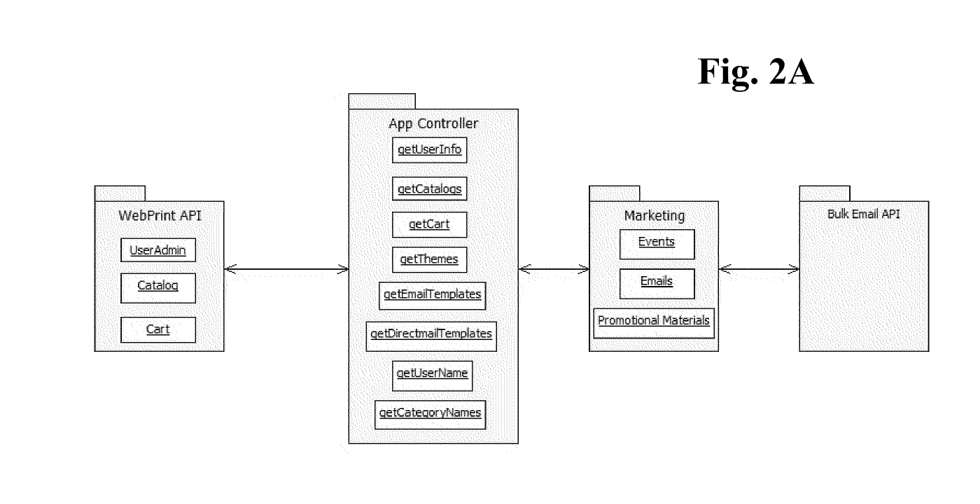

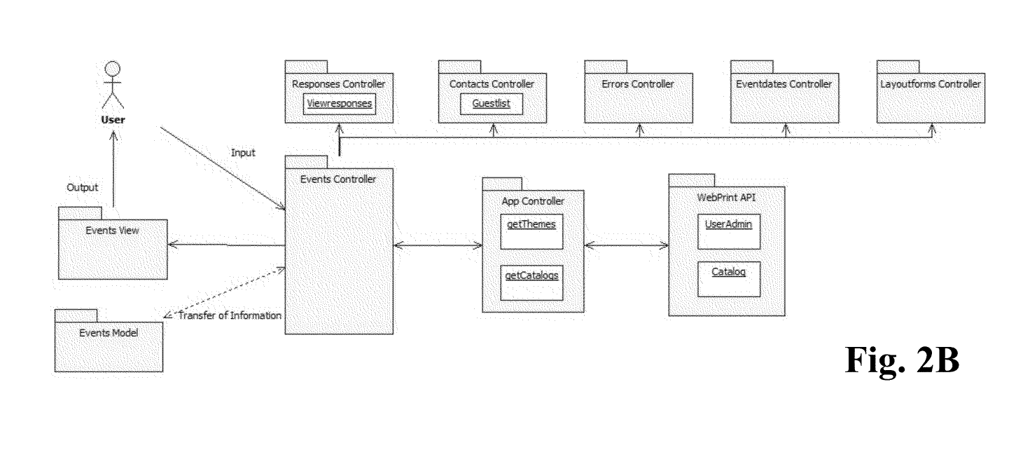

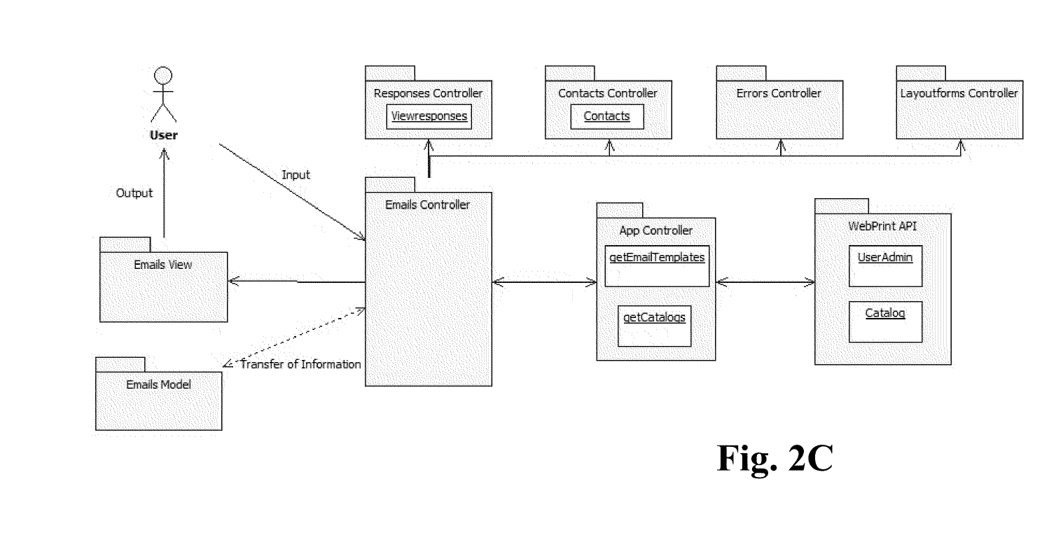

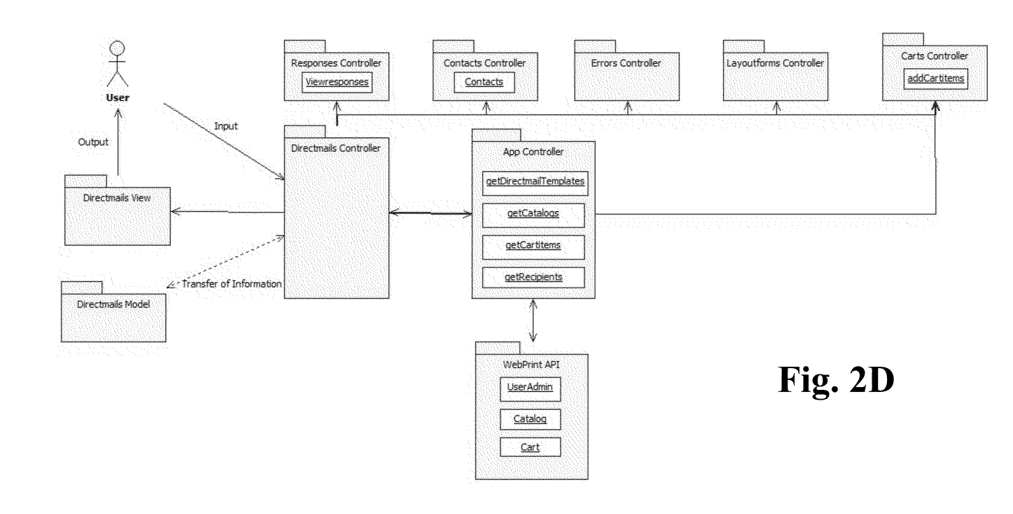

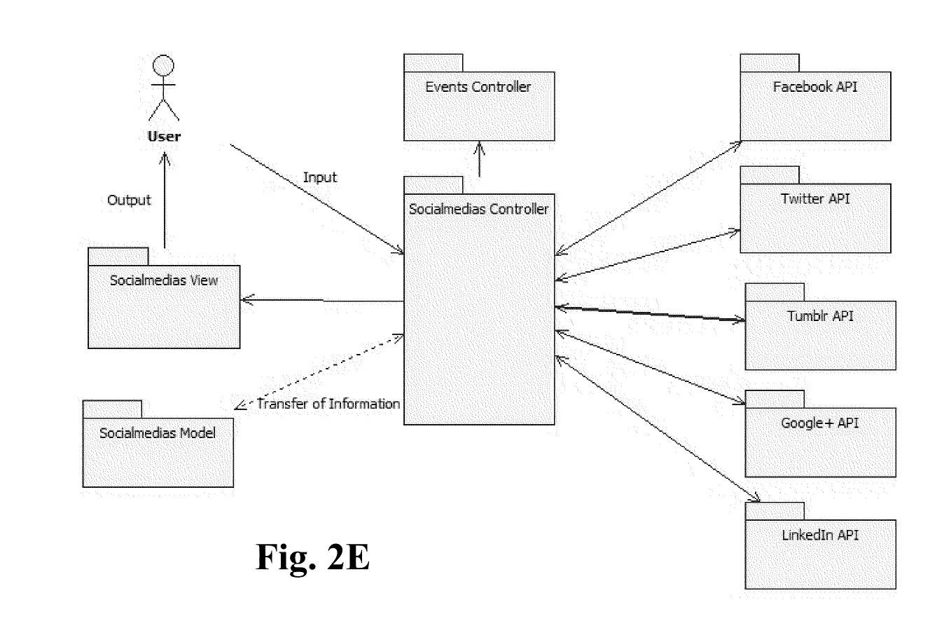

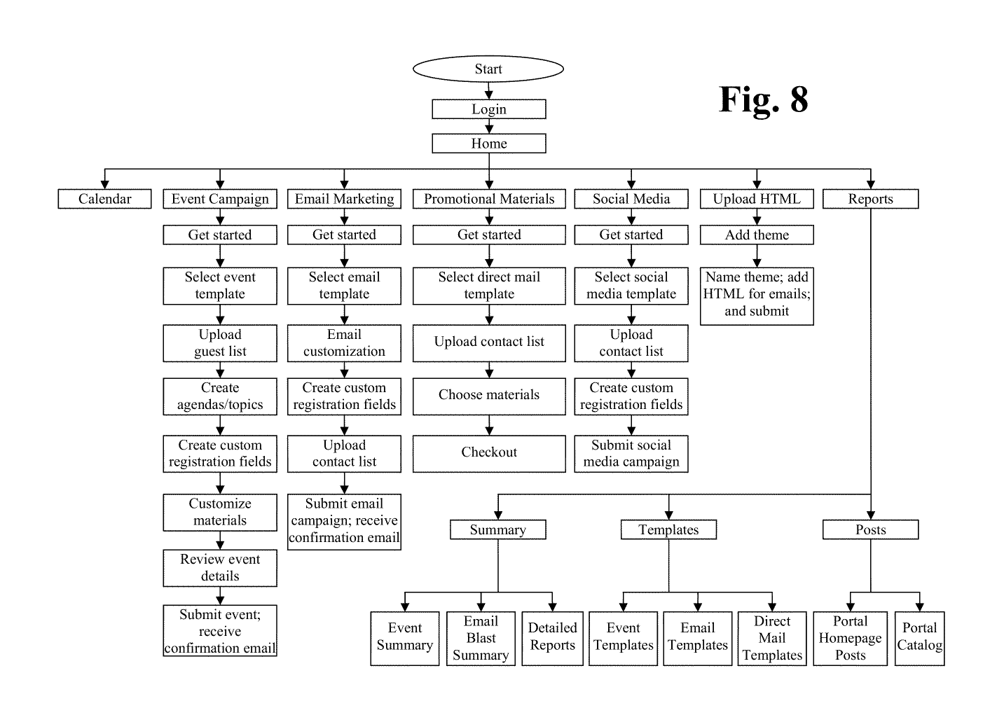

Such a marketing connection application provided in the system of FIG. 1A or in the system of FIG. 1B can be configured as shown in FIG. 2A. The software system for providing the marketing connection application includes a front end (“Marketing” in FIG. 2A) that controls the marketing connection application (including user interface and functions) provided to the user. Such front end provides a calendar functionality (discussed infra) which shares a schedule database with other portions of the marketing connection application, and the front end additionally includes an events controller (“Events” in FIG. 2A and “Events Controller” in FIG. 2B) for an event campaign process, an emails controller (“Emails” in FIG. 2A and “Emails Controller” in FIG. 2C) for an email marketing campaign process, and a promotional materials controller (“Promotional Materials” in FIG. 2A and “Directmails Controller” in FIG. 2D) for a direct mail campaign process. In the example shown in FIG. 2A, the user the marketing connection application allows the user to select any of three different work flows (as discussed infra with reference to FIG. 8), i.e. event development, email campaign and direct mail campaign, but the user may of course switch from one work flow to another or employ a combination of work flows to adapt the campaign in the manner as desired. In addition, the system may include a social media controller (“Socialmedias Controller” in FIG. 2E) as an add-on to allow the user to employ another mode of marketing delivery for the campaign. Each of the aforementioned software controllers (i.e. events controller, emails controller, promotional materials controller, social media controller) will be discussed in turn below.

Further, the front end is configured to access an application-programming interface (API) of an email application for bulk email, to allow the user to send emails to contacts or other destinations specified, for example, in a mailing list or some other database containing contact information for customers, invitees or other targeted audience. Such use of email may be employed not only in (of course) an email campaign, but also to communicate invitations, event updates, content of promotional materials that are transmitted by direct mail and/or e-mail, etc., or otherwise initiate a contact process (e.g., invitation to register at a Landings Page).

In addition, the front end is integrated with an application controller (“App Controller” in FIGS. 2A-2D) which operates automatically as a back-end to interface with databases, external applications, etc. The interface between the application controller and the external application may be based on XML script or Javascript query (i.e. get function) and comport with JSON (JavaScript Object Notation) for data interchange.

In the example shown in FIG. 2A, the application controller accesses a print application (“WebPrint”) API in order to obtain various functionalities that may be provided by such external application. In this example, the application controller is configured to include various functions (such as “getUserInfo”, “getUserName”, “getCatalogs”, “getCart”, “getThemes”, “getEmailTemplate”, “getDirectmailTemplate”, “getCategoryNames”, etc.) that allow the marketing connection application to inure the benefits of the functionalities (e.g., user administration for authentication and access control, catalog of pages and objects such as themes and templates, cart for ordering selected content/objects, etc.) that exist in the external application. Such approach is transparent to the user and provides improved convenience and overall operability to the user so that the user need not exit the marketing connection application to obtain the functionalities of the external application, nor does it require the user to struggle to devise a workflow to import content into the marketing connection application from the external application.

In the example of the WebPrint application, there are various functionalities and contents that a typical user of the marketing connection application may find useful. In the case of developing an event campaign, as discussed in more detail infra, a typical marketing connection application user might find it helpful to maintain a consistent theme (e.g., colors, borders, graphics, etc.) across the materials provided to the audience. The external application may provide a library (“Catalog” in FIGS. 2A and 2B) of such themes that permits the user to select and retrieve a desired theme from the library, without requiring the user to waste valuable creative resources towards creating a theme from scratch, when it can be readily obtained from the library. Likewise, the user may find other objects that might be useful to jump-start or enrichen the event campaign from the catalog of such objects provided by the external application. As shown in FIG. 2B, the events controller is configured to invoke, inter alia, the aforementioned getThemes and getCatalogs functions, in order to enable the event campaign to avail itself of useful functionalities of the WebPrint application. Further, the user can deploy a shopping cart functionality (“Cart” in FIG. 2A) of WebPrint, from within the marketing connection application, to place selected objects in the cart and defer checkout (i.e. ordering) until a later time.

Further, as discussed further infra, the marketing connection application maintains a collection of templates and models (e.g., in database 101b in system of FIG. 1A, or database 201a in system of FIG. 1B), and a typical user may very well find the use of models and templates to be helpful to accelerate event development, particularly when certain aspects are consistently present in most, if not all, events. Further, use of models and templates allows, when appropriate, a marketing department to standardize its presentations, although a user of the marketing connection application is by no means locked down to a fixed presentation approach.

As mentioned above, the events controller is a component of the front end of the marketing connection application, and it is largely responsible for controlling, with reference to event campaign models (“Events Model” in FIG. 2B), a process and user interface for the event campaign (“Events View” in FIG. 2B). Various features of the marketing connection application are useful to the typical user for developing the event campaign, and the tasks for providing such features are subdivided and allocated to subcontrollers (e.g., “Responses Controller”, “Contacts Controller”, “Errors Controller”, “Eventdates Controller”, “Layoutforms Controller”, as shown in FIG. 2B).

For example, the Eventdates subcontroller accesses the schedule database (e.g., in database 101b in system of FIG. 1A, or database 201a in system of FIG. 1B) that is commonly shared and used by the calendar functionality of the marketing connection application, and provides required date/schedule information when an event is being created, when event details are being reviewed and/or modified, when other tasks require date/schedule data, etc.

The Contacts subcontroller includes a Guestlist function that, for each event, provides a user interface (“Events View” in FIG. 2B) for generating, compiling and/or editing a guest list for the event and maintains the guest for the event (e.g., in database 101b in system of FIG. 1A, or database 201a in system of FIG. 1B).

The Layoutforms subcontroller operates to retrieve the appropriate form data (e.g., a model, a template, etc.) from the marketing database, and cause the retrieved form data to be reflected in the user interface, for various steps in the event campaign (such as, for example, create event, generate event agenda or topics, customize registration, customize event materials, review event details, finalize and submit event/materials for approval, etc.).

The Responses subcontroller operates to provide a user interface through which a user can view responses to the event invitation. Such response may be a reply e-mail, a response entered via a Landings page, a scanned image of a mailed response, etc.

The Errors subcontroller performs a consistency check, as a background process, of the event campaign data, and when appropriate, causes an error message to be displayed through the user interface. Such message may require the user to modify the current data for the event, and/or indicate that a default data conflict rule will be applied, and/or indicate the corrected data.

As discussed further infra, the events controller may be provided with an interface to various social media, such as shown in FIG. 2E. The social media interface includes a social media controller (“Socialmedias Controller” in FIG. 2E) which is configured to operate through an appropriate API (e.g., “Facebook API”, “Twitter API”, “Tumblr API”, “Google+API”, “LinkedIn API”, etc.) of the corresponding social media to allow the user to post selected materials onto the particular social media. That is, the social media controller operates, with reference to social media models (“Socialmedias Model” in FIG. 2E), to provide a suitable user interface for the particular social media (“Socialmedias View” in FIG. 2E). As should be appreciated by those skilled in the social media art, user/app credentials will typically be needed in order to post materials to an assigned social media page. Such user information (i.e. user ID, user credentials, customer key, etc.) are registered in the social media models and provided at an appropriate timing and in an appropriate format, as needed.

The emails controller, like the events controller, includes a Responses subcontroller (“Responses Controller”), Contacts subcontroller (“Contacts Controller”), Errors subcontroller (“Errors Controller”), Layout subcontroller (“Layoutforms Controller”), as shown in FIG. 2C, which operate to control, with reference to email campaign models (“Emails Model” in FIG. 2C), a process and user interface for the email campaign (“Emails View” in FIG. 2C). Such subcontrollers have functionalities that are similar to their respective counterparts in the events controller, but the presentation and the underlying data is somewhat different. For example, the Contacts subcontroller of the emails controller provides a Contacts function that is, of course, not event-specific but rather can be a mailing list used for one or more campaigns, and modified upon demand. Further, the emails controller employs a getEmailsTemplate function of the App Controller to obtain one or more email templates from the external application (i.e. WebPrint API in the example of FIG. 2C), instead of the GetThemes function of the App Controller.

Further, the promotional materials controller for a direct mail campaign process (FIG. 2D) is similar in many ways to the emails controller, but is different in a few aspects. The promotional materials controller operates to control, with reference to direct mail campaign models (“Directmails Model” in FIG. 2D), a process and user interface for the direct mail campaign (“Directmails View” in FIG. 2D). In addition to a Responses subcontroller (“Responses Controller”), Contacts subcontroller (“Contacts Controller”), Errors subcontroller (“Errors Controller”), Layout subcontroller (“Layoutforms Controller”), there is additionally provided a Carts subcontroller (“Carts Controller”), to control import of objects from the WebPrint application via the getCartitems function of the App Controller. Such additional provisions is available in the example of FIG. 2D because it was found that in direct mail campaigns, users more often (than in an email campaign or event campaign) resorted to objects from external applications (such as WebPrint) and moreover such user typically submitted jobs through the print application when the promotional materials were finalized (and approved). The promotional materials controller employs a getDirectmailsTemplates function and getRecipients functions, in addition to getCartitems and getCatalogs function, of the App Controller. The getRecipients function allows the user of the marketing connection application to supplement contacts data with data maintained in the WebPrint application of recipients to whom past jobs were delivered.

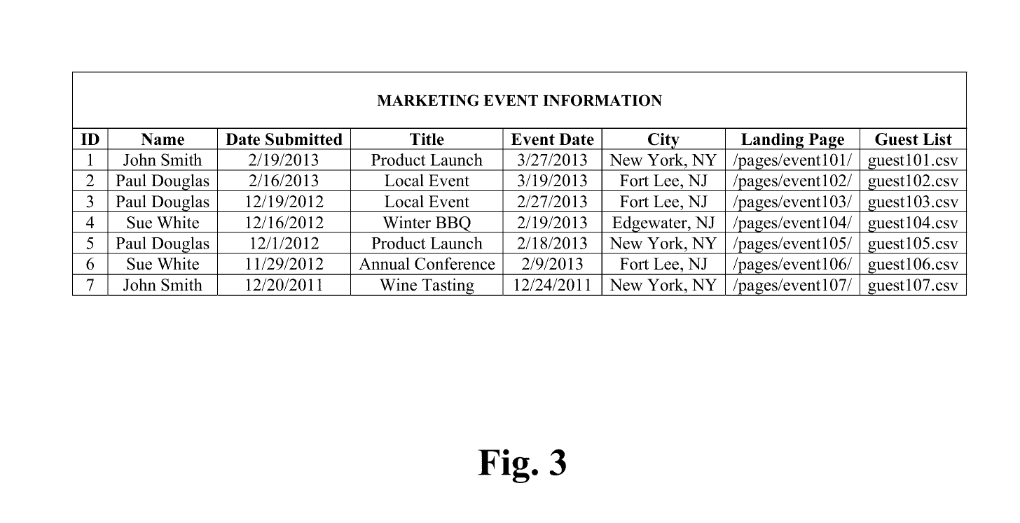

FIG. 3 shows an example of marketing event information (which may be a combination of event-specific details, customized marketing materials and other associated event-specific information) maintained, for example, by the marketing database management apparatus 101 (or 201). The event campaign information includes, for each marketing event created and submitted to the marketing database management apparatus 101, an event ID (e.g. “1”), the name of the user who submitted the marketing event (e.g. “John Smith”), the date on which the marketing event was submitted (e.g. “Feb. 19, 2013”), the title of the marketing event (e.g. “Product Launch”), the date of the marketing event (e.g. “Mar. 27, 2013”), the location of the marketing event (e.g. “New York, N.Y.”), the landing page through which guests and/or invitees may access the information regarding the marketing event (e.g. “/pages/event101/”), and the guest list including the guests invited to the marketing event (e.g. “guest101.csv”), as shown in FIG. 3.

The marketing event information and other information collected and/or stored in the system 100 is not limited to those discussed in the present disclosure, and may include other information relevant to providing marketing event development and management services. Such information can be stored in an internal storage resident in the marketing database management apparatus 101 and/or the web service providing apparatus 102. Alternatively, the information can be stored externally in a storage unit connected to the marketing database management apparatus 101 and/or the web service providing apparatus 102, or accessible via the networks 108 and 109, and retrieved as needed. For example, the information may be stored in one or more databases [e.g. off-the-shelf database applications based on SQL (Structured Query Language), or other customized database applications with search/query function]. If the information is stored in more than one location, the information may be synced, for example, periodically or upon a user request.

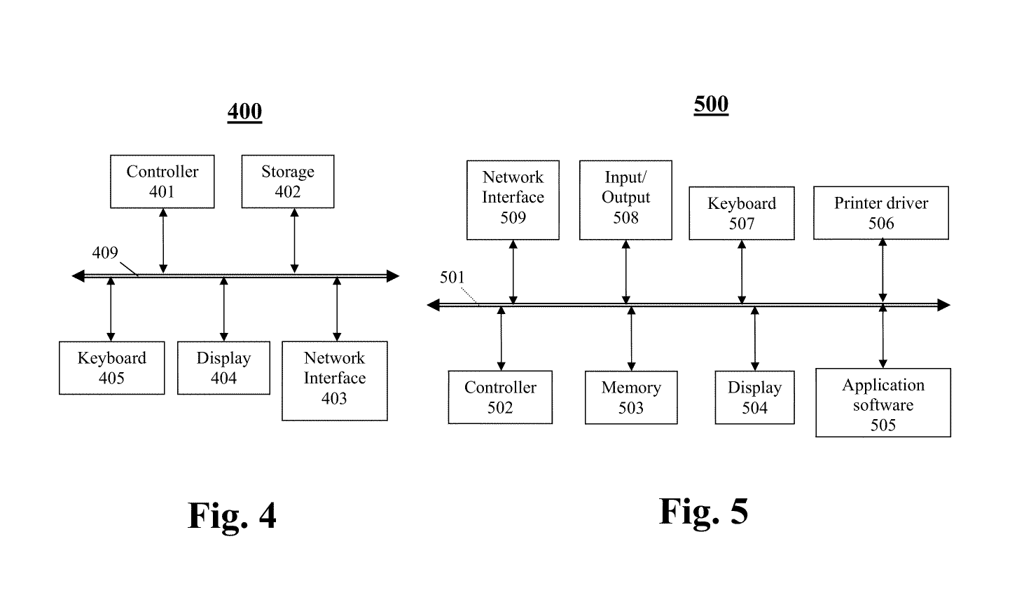

FIG. 4 shows an exemplary constitution of a computing device that can be configured (for example, through software) to operate (at least in part) as the web service providing apparatus 102 of FIG. 1A, or the marketing connection service providing apparatus 203 of FIG. 1B. As shown in FIG. 4, the management unit 400 includes a controller (or central processing unit) 401 that communicates with a number of other components, including memory or storage part 402, network interface 403, display 404 and keyboard 405, by way of a system bus 409.

The management unit 400 may be a special-purpose device (such as including one or more application specific integrated circuits or an appropriate network of conventional component circuits) or it may be software-configured on a conventional personal computer or computer workstation with sufficient memory, processing and communication capabilities to operate as a terminal and/or server, as will be appreciated to those skilled in the relevant arts.

In the management unit 400, the controller 401 executes program code instructions that control device operations. The controller 401, memory/storage 402, network interface 403, display 404 and keyboard 405 are conventional, and therefore in order to avoid obfuscating the inventive aspects of this disclosure, such conventional aspects will not be discussed in detail herein.

The management unit 400 includes the network interface 403 for communications through a network, such as communications through the network 109 with the terminal 103 in FIG. 1A. However, it should be appreciated that the subject matter of this disclosure is not limited to such configuration. For example, the management unit 400 may communicate with client terminals through direct connections and/or through a network to which some components are not connected. As another example, the management unit 400 does not need to be provided by a server that services terminals, but rather may communicate with the devices on a peer basis, or in another fashion.

The web service providing apparatus or the marketing connection service providing apparatus of the present disclosure is not limited to a server or computer, but can be manifested in any of various devices that can be configured to communicate over a network and/or the Internet.

An exemplary constitution of the terminal 103 of FIG. 1A (for example, as a computer) is shown schematically in FIG. 5. In FIG. 5, computer 500 includes a controller (or central processing unit) 502 that communicates with a number of other components, including memory 503, display 504, keyboard (and/or keypad) 507, other input/output (such as mouse, touchpad, stylus, microphone and/or speaker with voice/speech interface and/or recognition software, etc.) 508, network interface 509, print driver 506 and application software 505, by way of an internal bus 501.

The memory 503 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc.].

The network interface 509 provides a connection (for example, by way of an Ethernet connection or other network connection which supports any desired network protocol such as, but not limited to TCP/IP, IPX, IPX/SPX, or NetBEUI) to the network to which the computer 500 is connected (e.g. network 109 of FIG. 1A).

The print driver 506 and application software 505 are shown as components connected to the internal bus 501, but in practice are typically stored in storage media such as a hard disk or portable media, and/or received through the network, and loaded into memory 503 as the need arises.

Depending on the type of the particular terminal device, one or more of the components shown in FIG. 5 may be missing. For example, a particular mobile phone may be missing the print driver 506 and the keyboard 507.

Additional aspects or components of the computer 500 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

The terminal 103 of FIG. 1A and the terminal 204 of FIG. 1B (or other devices described in the present disclosure) may be any device including but not limited to a personal, notebook or workstation computer, a terminal, a kiosk, a personal digital assistant (PDA), a tablet computing device, a smartphone, a scanner, a printer, a facsimile machine, a multi-function device (MFD), a server, a mobile phone or handset, another information terminal, etc. Each device may be configured with software allowing the device to communicate through a network with a web service providing apparatus and/or a marketing connection service providing apparatus in the present disclosure.

In addition, the marketing event creation part 102a of the web service providing apparatus 102 may provide a login UI (user interface) for receiving login credentials from the user at the terminal 103, and authenticating the user based on the received login credentials.

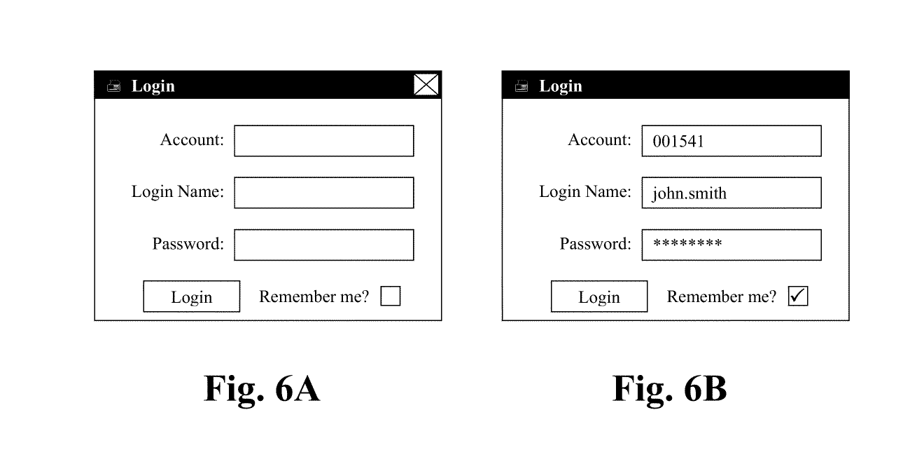

For example, FIG. 6A shows an example of such login UI displayed to the user at the terminal 103. The login screen shown in FIG. 6A allows the user at the terminal 103 to enter the account number, login name and password of the user. As shown in FIG. 6B, the user at the terminal 103 can provide his or her account number, login name and password and activate the “login” button to be authenticated, for example, either as a regular user or an administrative user.

The event selection GUI 103a-1 and the event campaign GUI 103a-2 (and other GUIs provided to the user by the web service providing apparatus 102) may display different GUI elements depending on the status of the logged-in user.

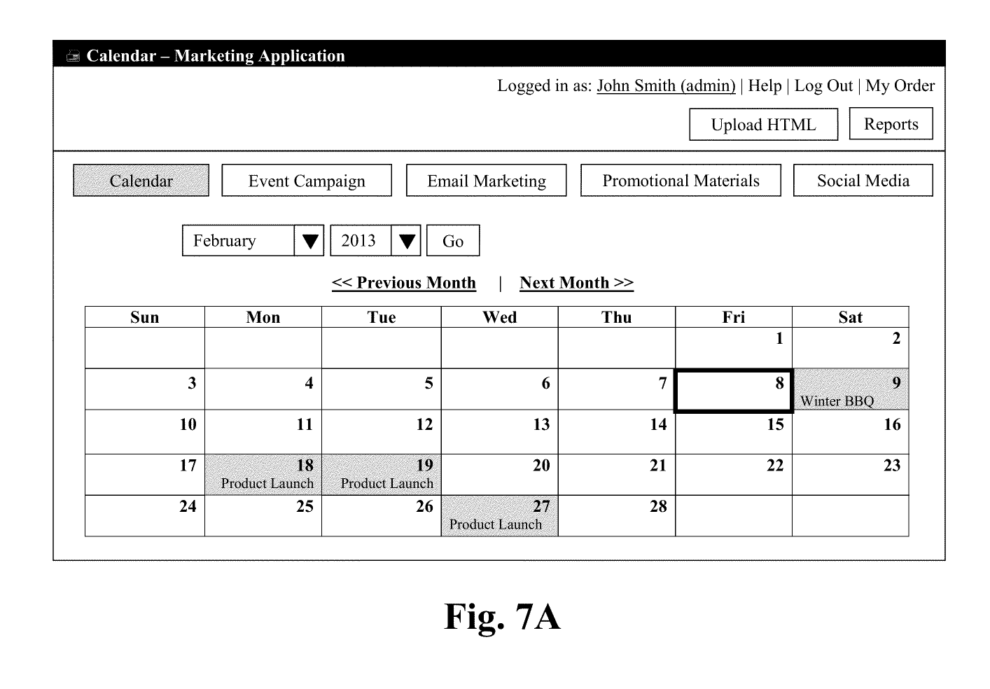

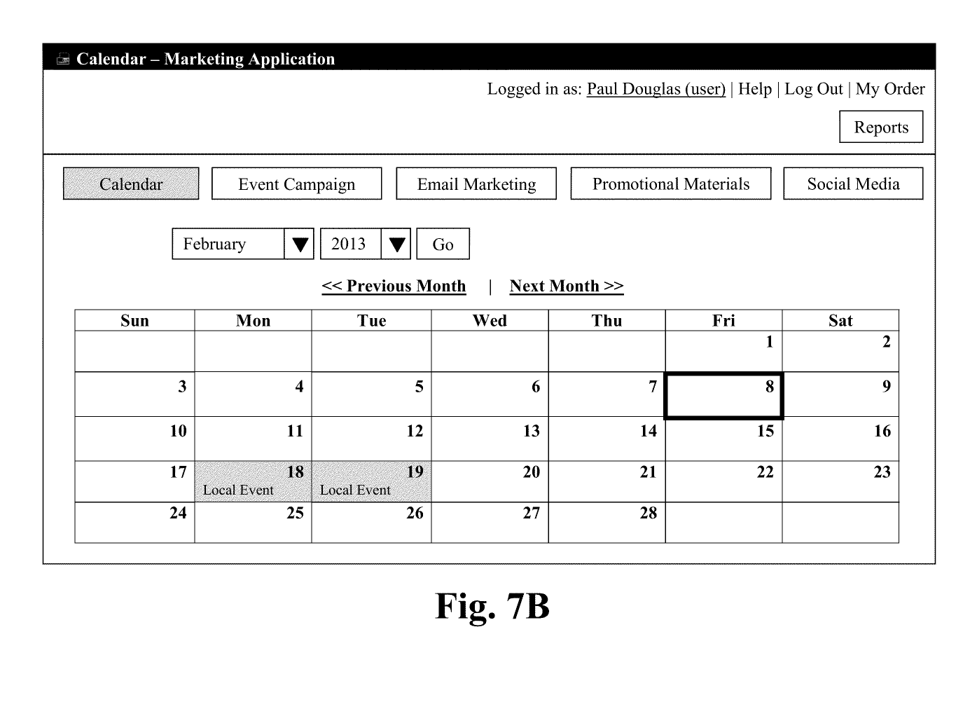

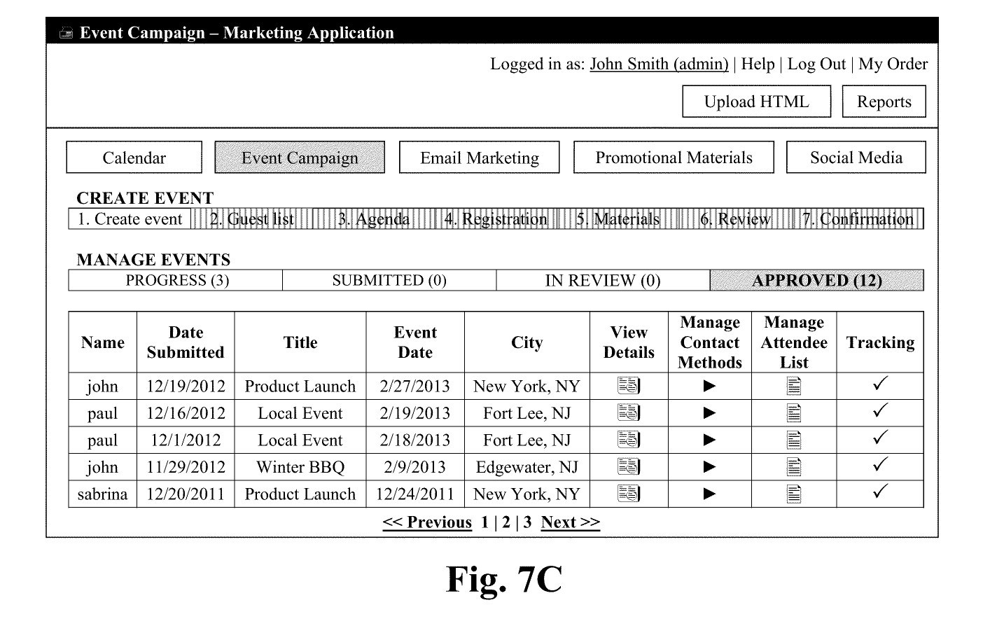

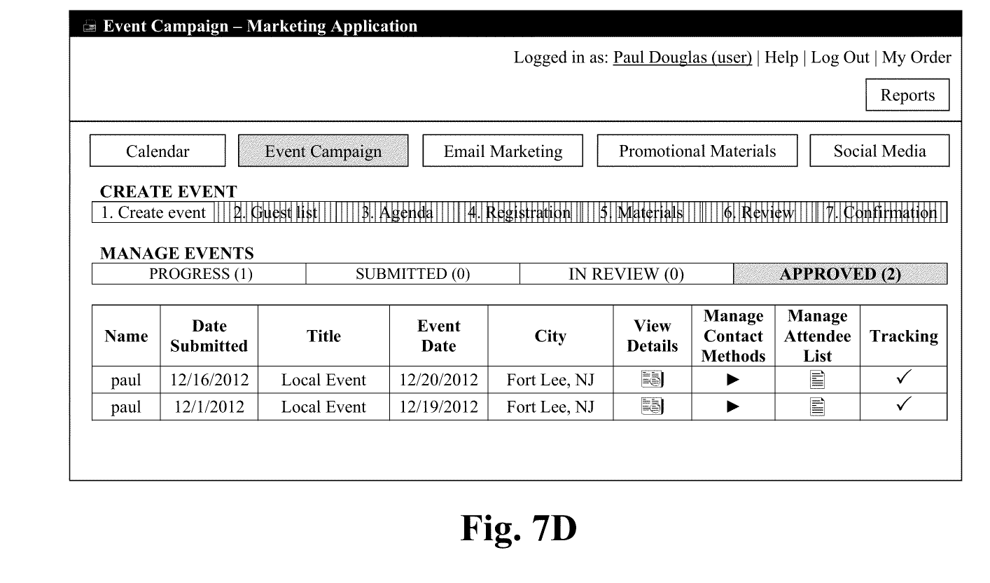

For example, FIG. 7A shows an example of the event selection GUI 103a-1 displayed to the user at the terminal 103 in a calendar view format. As indicated at the top right corner of the screen, the logged-in user “John Smith” is an administrator and may have access to all the marketing events stored in the marketing database 101b. In contrast, in the example of FIG. 7B, which shows the event selection GUI 103a-1 displayed in a calendar view format to another user “Paul Douglas” who is a regular user. As shown in FIG. 7B, some marketing events to which “Paul Douglas” does not have access are omitted from the calendar view. In addition, one or more functionalities may be available or unavailable to certain users depending on the access level of the user. For example, in the example of FIG. 7B, the “Upload HTML” button displayed in FIG. 7A is missing.

As shown FIGS. 7A and 7B, the event selection GUI 103a-1 further includes the “calendar” button for viewing the marketing events in the calendar view format, the “event campaign” button for viewing a list of marketing events and creating a new marketing campaign, the “email marketing” button for viewing a list of email campaigns and creating a new email campaign, the “promotional materials” button for viewing a list of direct mail campaigns and creating a new direct mail campaign, the “social media” button for viewing a list of social media posting campaigns and creating a new social media posting campaign, the “upload HTML” button for configuring the various templates and themes for creating marketing event campaigns and uploading images, files, web pages to be used in the various marketing event campaigns, and the “reports” button for generating and viewing various reports (e.g. guest/invitee responses and/or trends, history of marketing events, etc.).

FIGS. 7C and 7D show examples of the event selection GUI 103a-1 in a list view format. In FIG. 7C, the logged-in user “John Smith” is an administrator, so he can see all the marketing events existing in the marketing database 101b. On the other hand, as shown in FIG. 7D, regular users may be restricted to viewing only the marketing events they created or submitted.

FIG. 8 shows a diagram illustrating typical workflows within the marketing connection application. As shown in FIG. 8, after starting the marketing connection application (e.g. marketing connection service client 204a of FIG. 1B), the user logs in (e.g. FIGS. 6A and 6B) and reaches the home screen (e.g. FIGS. 7A-7D). From the home screen, the user can choose from a variety of options depending on the task he or she wishes to accomplish (e.g. calendar, event campaign, email marketing, promotional materials, social media, upload HTML and reports). Each of the options is further discussed infra (calendar is discussed above with reference to FIGS. 7A and 7B). With reference to FIGS. 9A-9H, the event campaign GUI 103a-2 according to an exemplary embodiment is described.

FIG. 9A shows an example of the event creation and development part of the event campaign GUI 103a-2 (Events View in FIG. 2B), which is displayed to the user when the user activates the “create event” button from the screen shown in FIG. 8A or 8B. As shown in FIG. 9A, details of the marketing event to be created are to be supplied by the user at the terminal 103 (e.g. event name, requester name, requester email, event description, date and time of the event, location name, phone number, address, etc.). Further, the user may select an event template from the list of templates displayed at the bottom of the screen. The user may activate the “preview” button to preview the selected template customized to include all the event-specific details specified by the user. The user may save his or her progress by activating the “save progress” button.

When the user activates the “step 2>>” button, a guest list access part of the event campaign GUI 103a-2 may be displayed to the user, as shown in FIG. 9B. In the example of FIG. 9B, the user may download the existing contact list (including contact information of the guests invited to the event), download a test list if no such contact list exists, or upload a contact list which includes the addresses (e.g. email address or mailing address) of the guests to be invited to the marketing event. The uploaded contact list may be further edited by activating the “edit” button.

When the user activates the “step 3>>” button, the progress is saved and an event agenda access part included in the event campaign GUI 103a-2 is displayed to the user, as shown in FIG. 9C. The event agenda access part creates and maintains an event agenda for the marketing event, and provides the event agenda, upon request by the user, for modification. As shown in FIG. 9C, agendas created by the user are displayed on the right side of the screen.

When the user activates the “step 4>>” button, a registration customization interface of the event campaign GUI 103a-2 is displayed to the user, as shown in FIG. 9D. The registration customization interface allows the user to customize information fields of a registration GUI to be provided at a registration page (e.g. a page via which the user registers for the marketing event). There may be a standard set of questions to be asked in the registration page by default. As shown in FIG. 9D, the registration fields created by the user are shown in the right side of the screen.

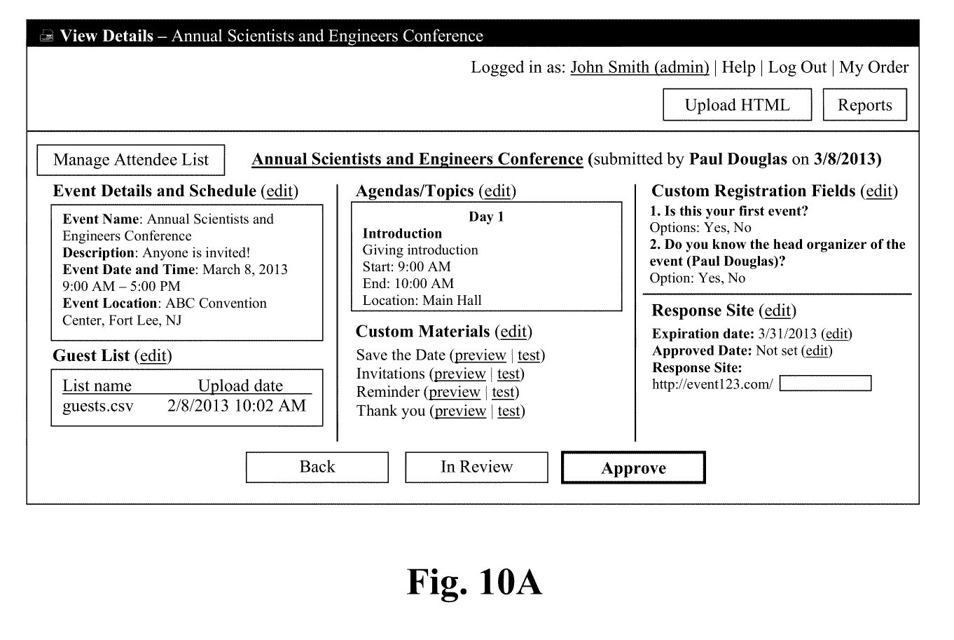

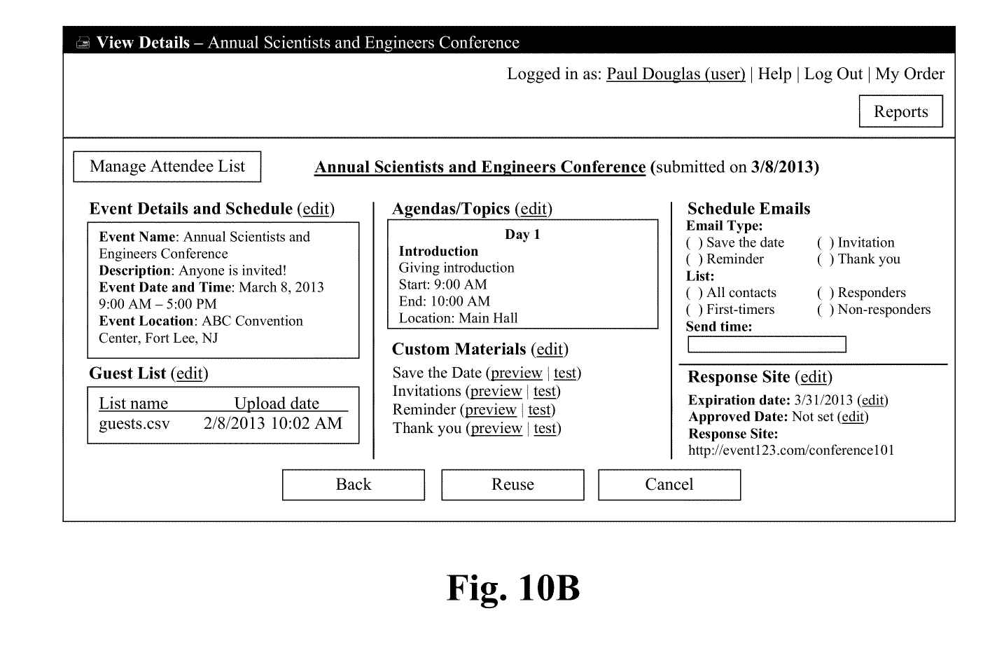

When the user activates the “step 5>>” button, the customizing materials GUI of the event campaign GUI 103a-2 is displayed to the user, as shown in FIG. 9E. The customizing materials GUI provides GUI parts for user selection of a marketing template and populating the selecting marketing template with event information maintained in the marketing object, for user selection of already-generated materials. Further the customizing materials GUI provides GUI parts for user modification of the populated marketing template and/or already-generated materials (e.g. as described infra with reference to FIG. 10A) to form customized marketing materials for the selected marketing event and for causing the customized marketing materials to be maintained in association with the marketing object for the selected marketing event.

To customize the materials, the user can choose the type of document the user wishes to customized (e.g. invitation, save-the-date, reminder, thank-you note, etc.), and further choose from a plurality of templates (e.g. using the drop-down menu) and preview the chosen template including the event-specific details specified by the user (e.g. by activating the “preview” button).

When the user activates the “step 6>>” button, the review event information GUI of the event campaign GUI 103a-2 is displayed to the user, as shown in FIG. 9F. The review event information GUI provides GUI parts for user selection of one or more of the event-specific details, customized marketing materials and other associated event-specific information, for the marketing event, for editing (e.g. by clicking on “edit” corresponding to the section that the user wishes to edit).

Once the user activates the “submit” button, the event submission part of the event campaign GUI 103a-2 is displayed to the user, as shown in FIG. 9G, indicating that the marketing object, associated event-specific details, customized marketing materials and other associated event-specific information, for the marketing event, have been submitted for approval by an event administrator.

As shown in FIG. 9H, the newly created marketing event is now listed under the “submitted” section of the event selection GUI 103a-1.

The steps for creating a new marketing event (e.g. as illustrated in FIGS. 9A-9H) are not limited to those discussed in the present disclosure, and one or more of the steps involved in creating the new marketing event may be made optional, and one or more steps may be added in addition to the steps discussed herein.

With reference to FIGS. 10A and 10B, the GUI for displaying the details of an existing marketing event according to an exemplary embodiment is described.

In FIG. 10A, the details of the newly submitted marketing event are shown, for example, when the user activates the “view details” button from the screen shown in FIG. 9H. In the example of FIG. 10A, the logged-in user is a supervisor or administrator, so the user has the option of indicating that the submitted marketing event is now in review (e.g. by activating the “in review” button at the bottom of the screen) and approving the submitted marketing event (e.g. by activating the “approve” button). In contrast, in the example of FIG. 10B, the logged-in user is a regular user, so the user may view and edit the details of the marketing event, and reuse the marketing event to create new marketing events, for example, by activating the “reuse” button at the bottom of the screen.

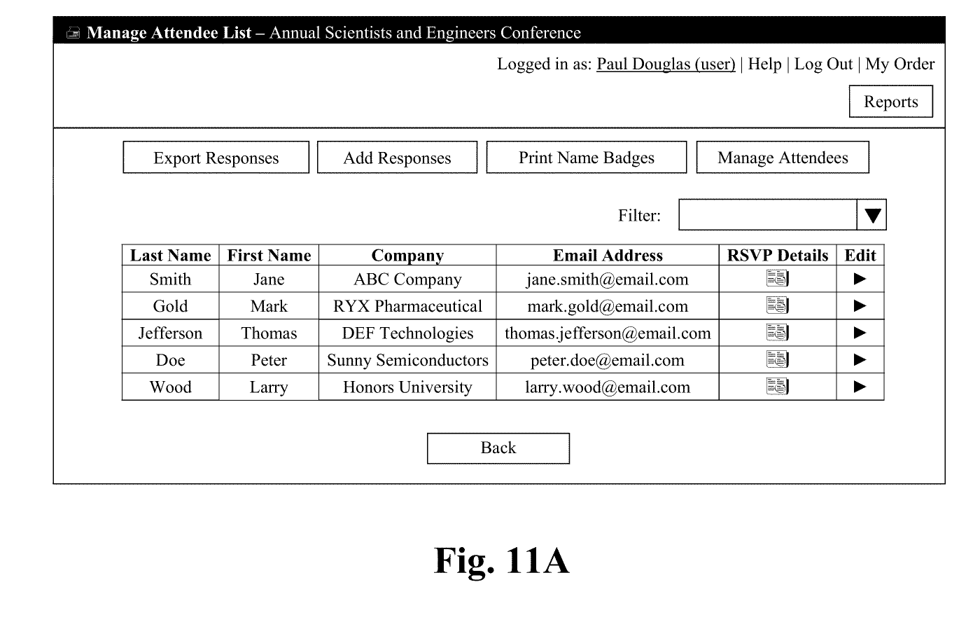

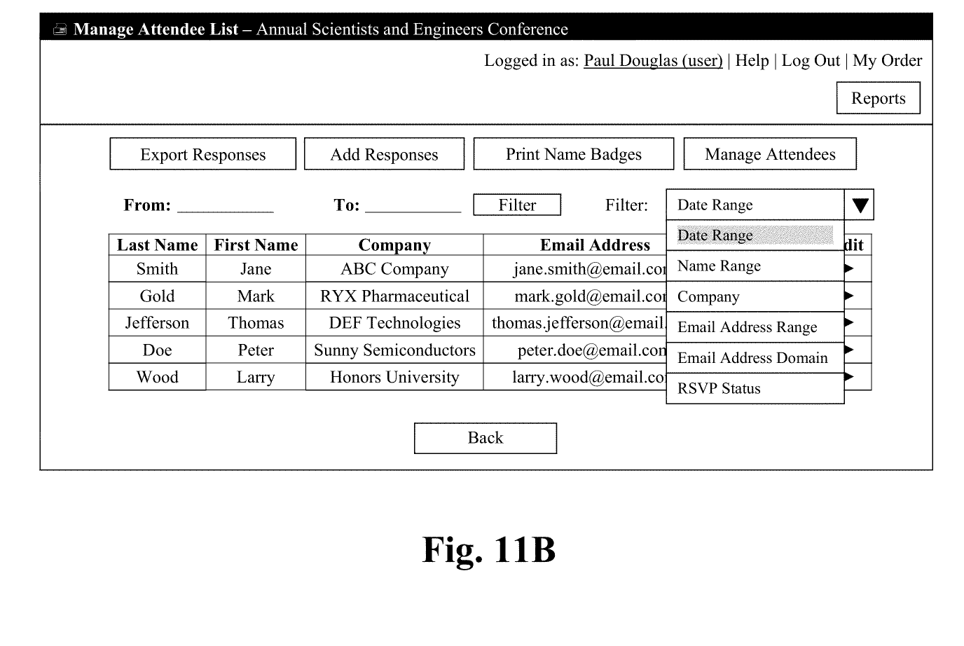

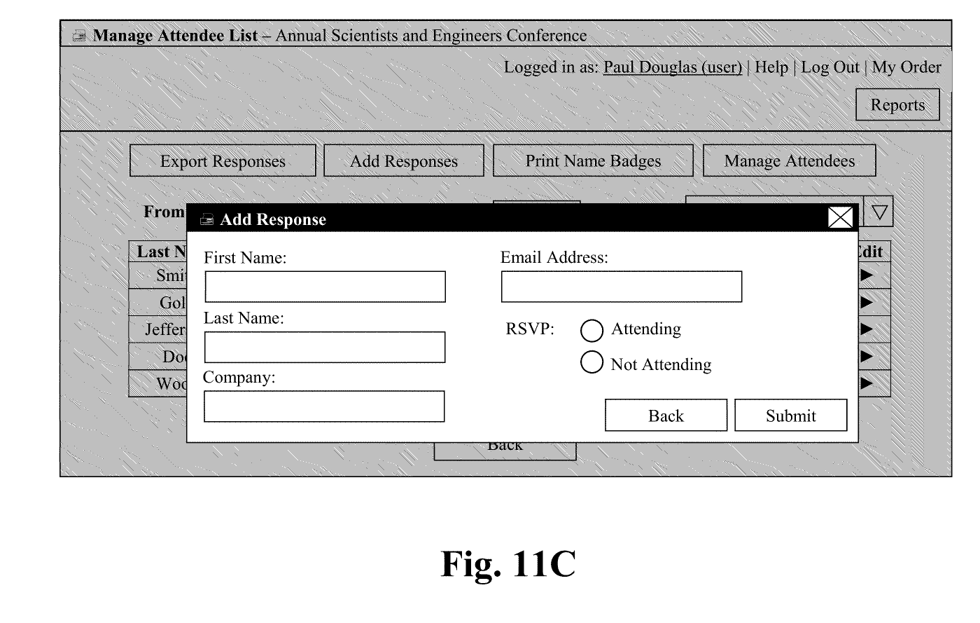

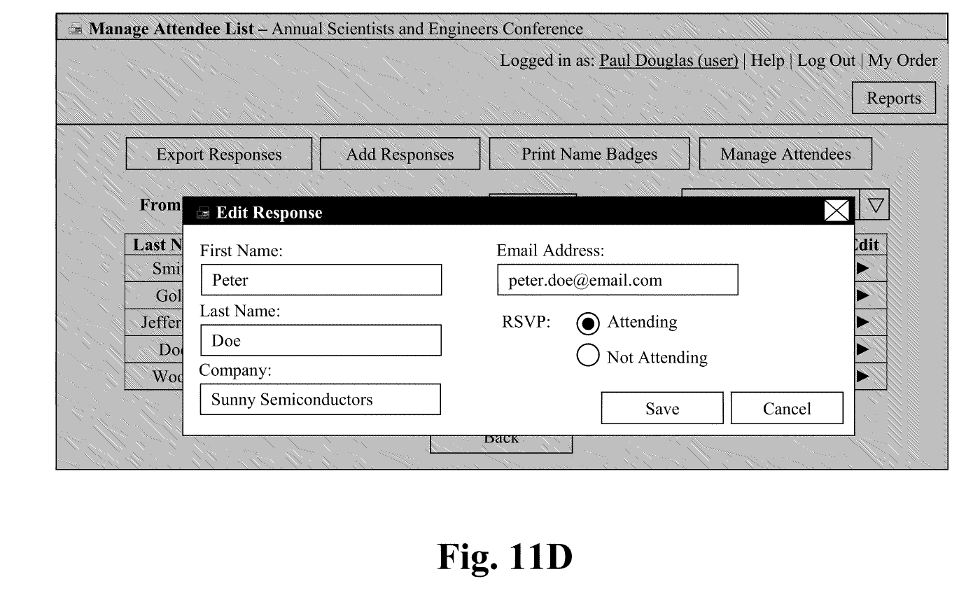

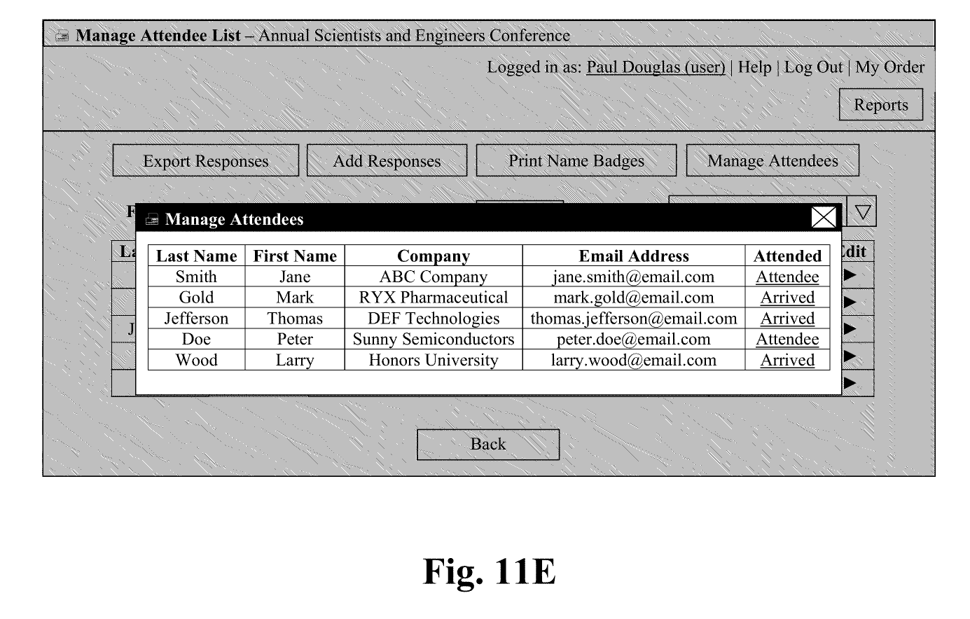

With reference to FIGS. 11A-11E, the GUI for managing a list of attendees for a particular marketing event, according to an exemplary embodiment, is described.

FIG. 11A shows a list of attendees displayed to the user, when the user, for example, activates the “manage attendee list” button from the screen of FIG. 10B. The list of attendees includes the attendees who have submitted responses in connection with the marketing event (e.g. from a web site created for the marketing event). The user can view the response detail by clicking on the “RSVP Details” button and edit the entries by clicking on the “edit” button. For example, the list of attendees displayed in FIG. 11A represents responses acquired via the landing page (e.g. “http://event123.com/conference101” in the example of FIG. 10B) corresponding to the event.

The “filter” drop-down menu can be used to filter the list of attendees. As shown in FIG. 11B, the filters in the drop-down menu may include “date range”, “name range”, “company”, “email address range”, “email address domain” and “RSVP status”.

The “add response” button shown in FIG. 11B may be used to manually add an entry to the list of attendees, as shown in FIG. 11C. Similarly, the “edit” button may be used to edit the entries in the list of attendees, as shown in FIG. 11D. The “manage attendees” button may be used to indicate which attendees attended the marketing event, as shown in FIG. 11E.

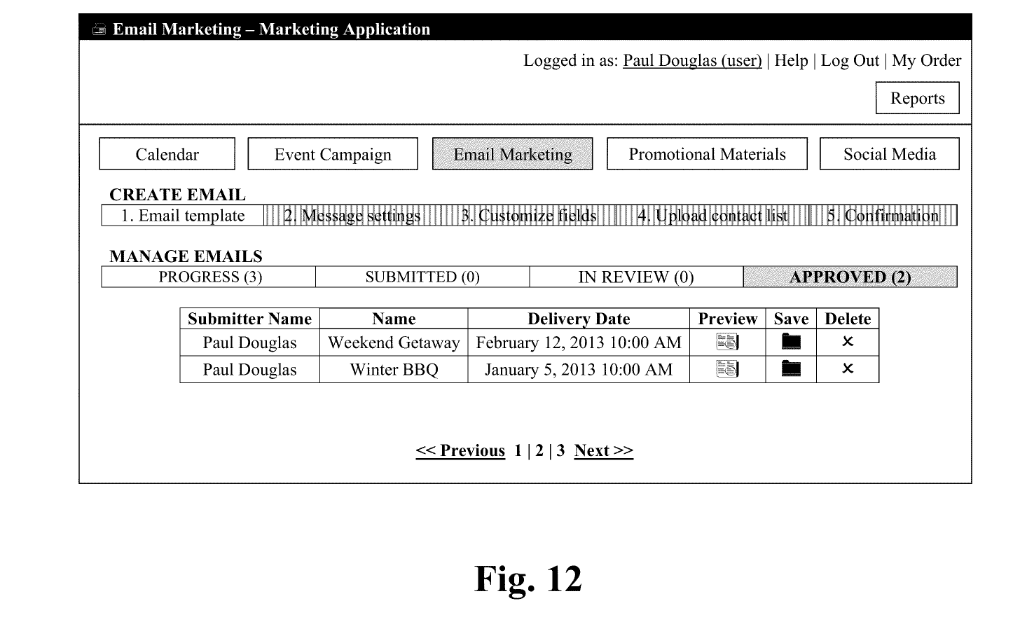

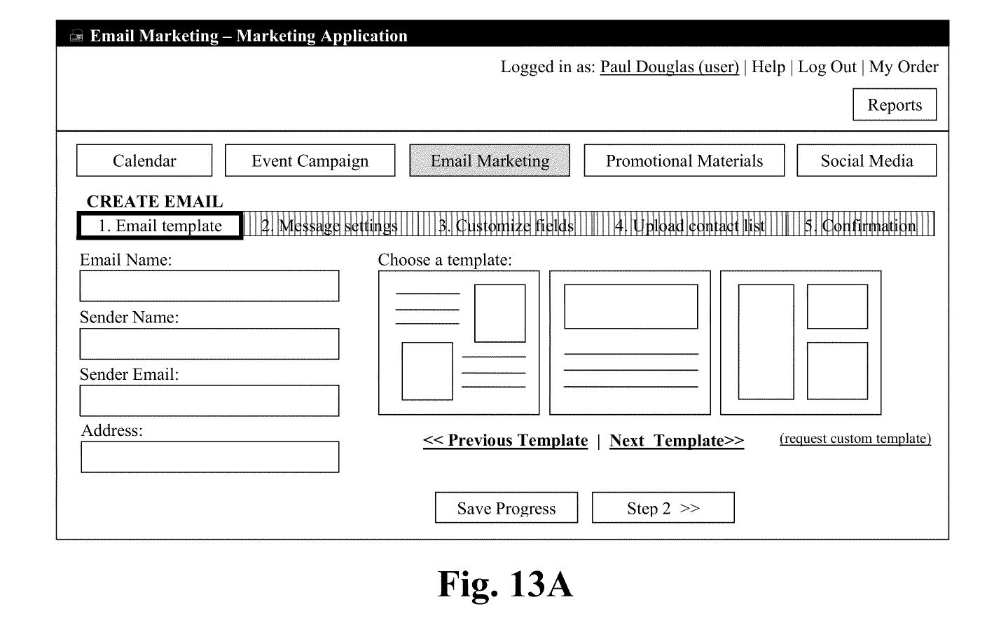

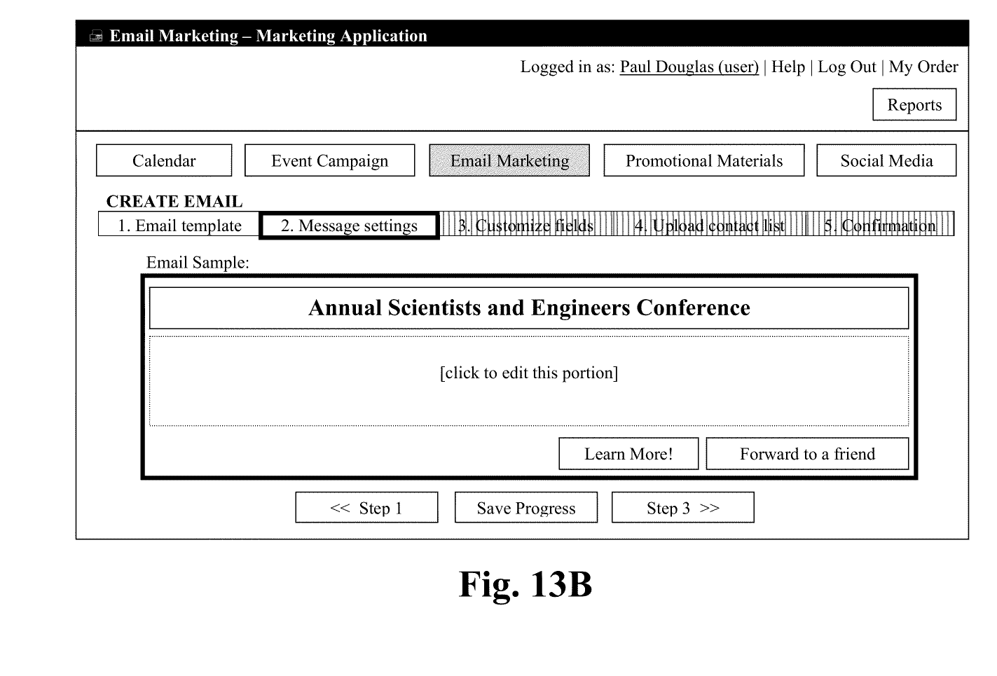

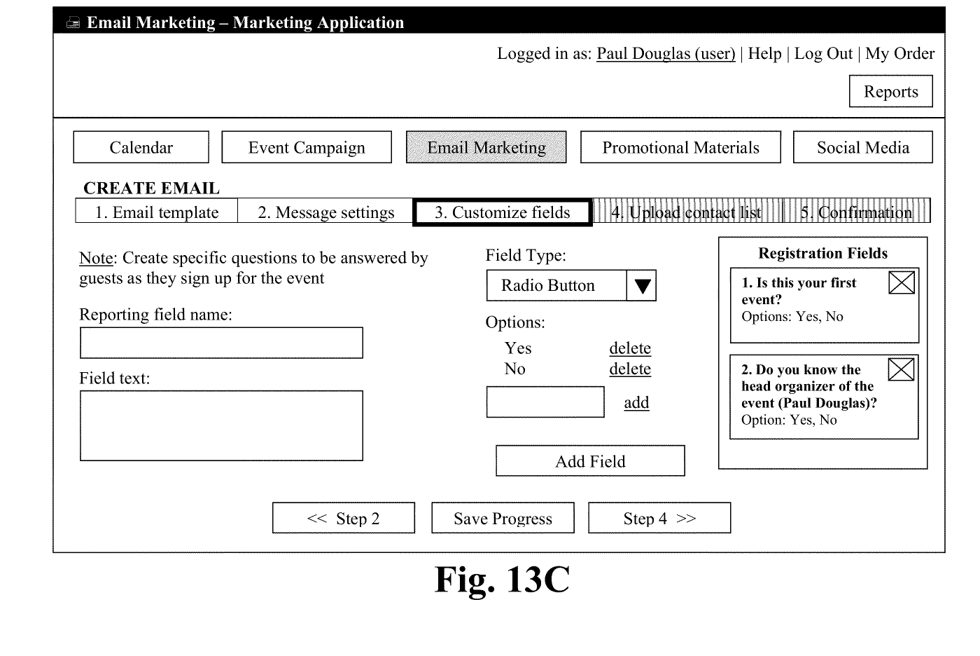

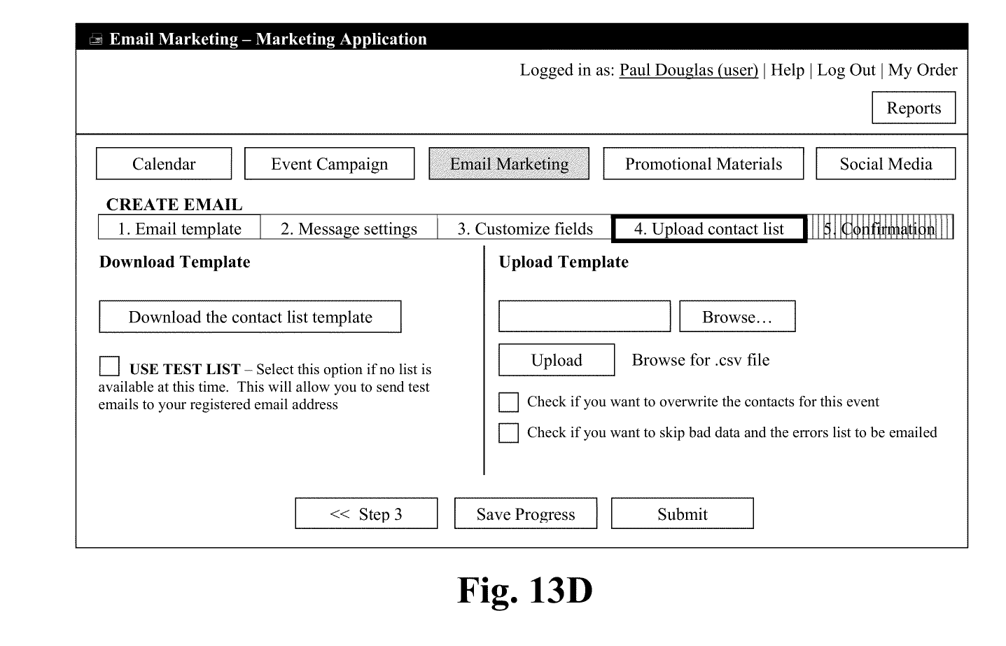

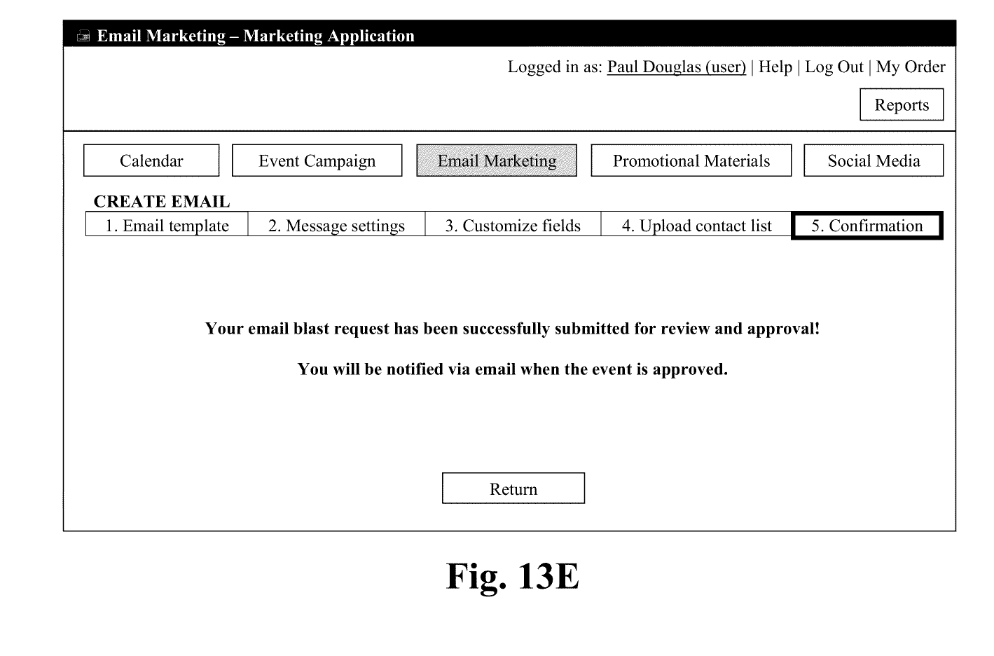

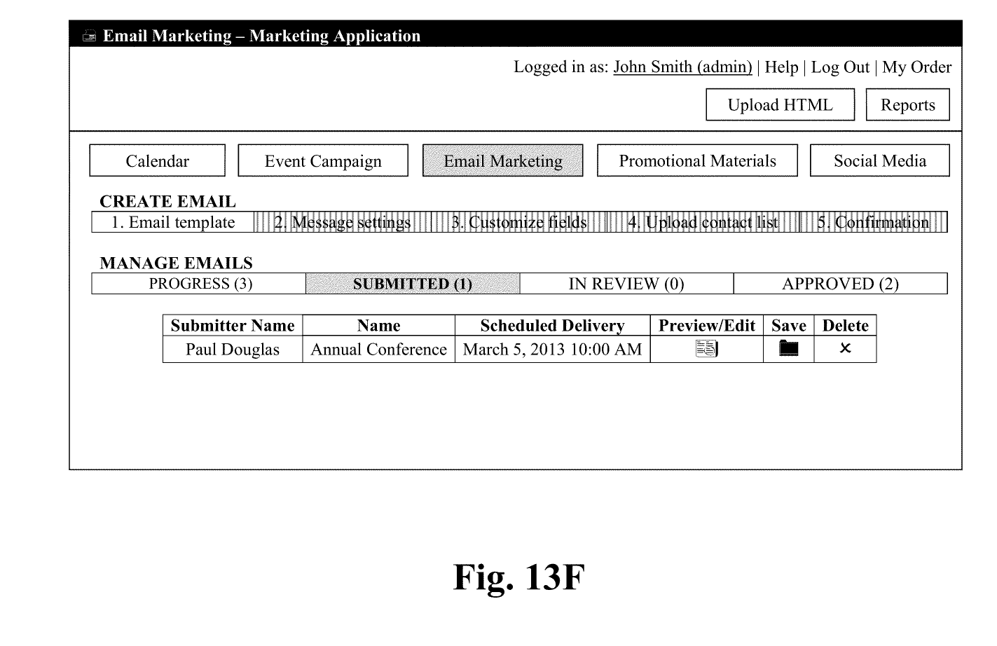

FIG. 12 shows an e-mail marketing user interface (Emails View in FIG. 2C), which is displayed to the user when the user activates the “email marketing” button at the top of the screen. In the example of FIG. 12, a list of the email campaigns that are approved are displayed in a list view format. When the user clicks on the “email template” button under “create email”, a GUI shown in FIG. 13A is displayed to the user.

With reference to FIGS. 13A-13F, the GUI for creating a new email campaign for a marketing event, according to an exemplary embodiment, is described.

FIG. 13A shows an example of an email marketing creation GUI, according to an exemplary embodiment. As shown in FIG. 13A, the user can specify event-specific details and specify a template for the email campaign. If the user is not satisfied with the provided templates, the user may request a custom template by clicking on the link “request custom template”. When the user activates the link, the user may be allowed to describe the template that he or she wishes to use, and such description along with her request may be transmitted to an administrator.

When the user activates the “step 2>>” button, a sample email sent to the invitees are displayed to the user, as shown in FIG. 13B. The user can edit portions of the sample email, as indicated in FIG. 13B.

When the user activates the “step 3>>” button, a GUI for customizing the registration fields of the email campaign is displayed to the user, as shown in FIG. 13C. The GUI allows the user to customize information fields of a registration GUI to be provided at a registration page (e.g. a page via which the user registers for the marketing event). There may be a standard set of questions to be asked in the registration page by default. As shown in FIG. 13C, the registration fields created by the user are shown in the right side of the screen.

When the user activates the “step 4>>” button, a guest list access GUI may be displayed to the user, as shown in FIG. 13D. In the example of FIG. 13D, the user may download the existing guest list, download a test list if no such is existing, or upload a guest list which includes the addresses (e.g. email address) of the guests to be invited to the marketing event.

Once the user activates the “submit” button, a confirmation screen is displayed to the user, as shown in FIG. 13E, indicating that the email campaign has been submitted for approval by an event administrator.

As shown in FIG. 13F, the newly created email campaign is now listed under the “submitted” section of the event selection GUI 103a-1.

The steps for creating a new email campaign (e.g. as illustrated in FIGS. 13A-13F) are not limited to those discussed in the present disclosure, and one or more of the steps involved in creating the new email campaign may be made optional, and one or more steps may be added in addition to the steps discussed herein.

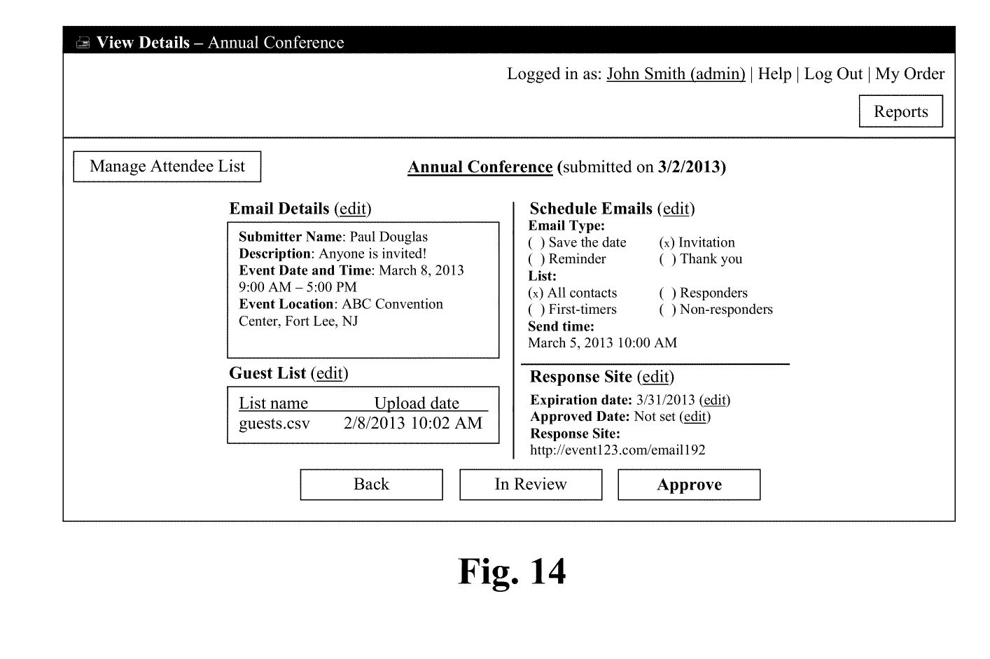

With reference to FIG. 14, the GUI for displaying the details of an existing email campaign, according to an exemplary embodiment, is described.

In FIG. 14, the details of the newly submitted email campaign are shown, for example, when the user activates the “preview/edit” button from the screen shown in FIG. 13F. In the example of FIG. 14, the logged-in user is an administrator, so the user has the option of indicating that the submitted marketing event is now in review (e.g. by activating the “in review” button at the bottom of the screen) and approving the submitted marketing event (e.g. by activating the “approve” button). In the example of FIG. 14, the emails are already scheduled to be sent out (e.g. Mar. 5, 2013 10:00 AM). However, in another exemplary embodiment, the scheduling of the emails may take place only after the administrator has started reviewing or has approved the email campaign.

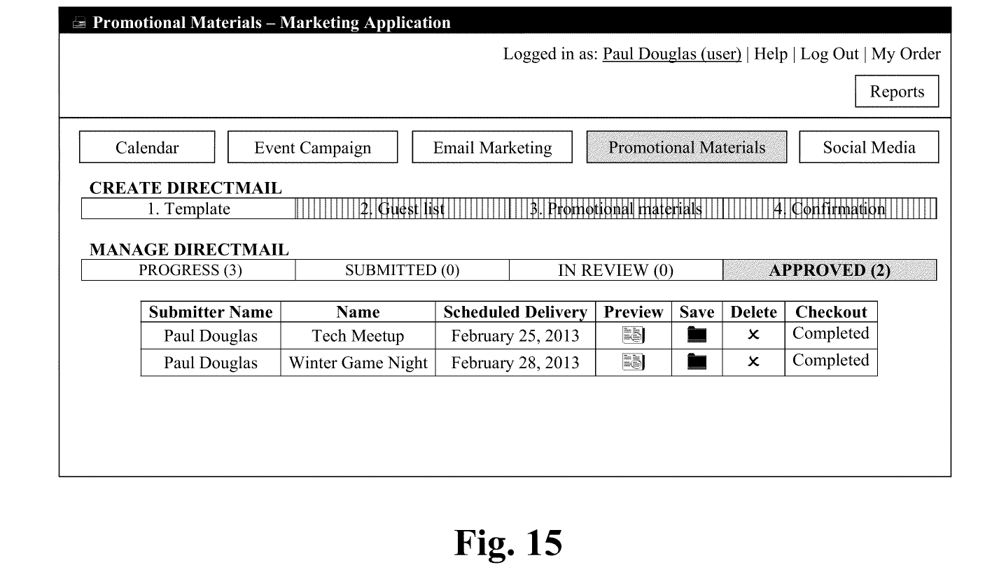

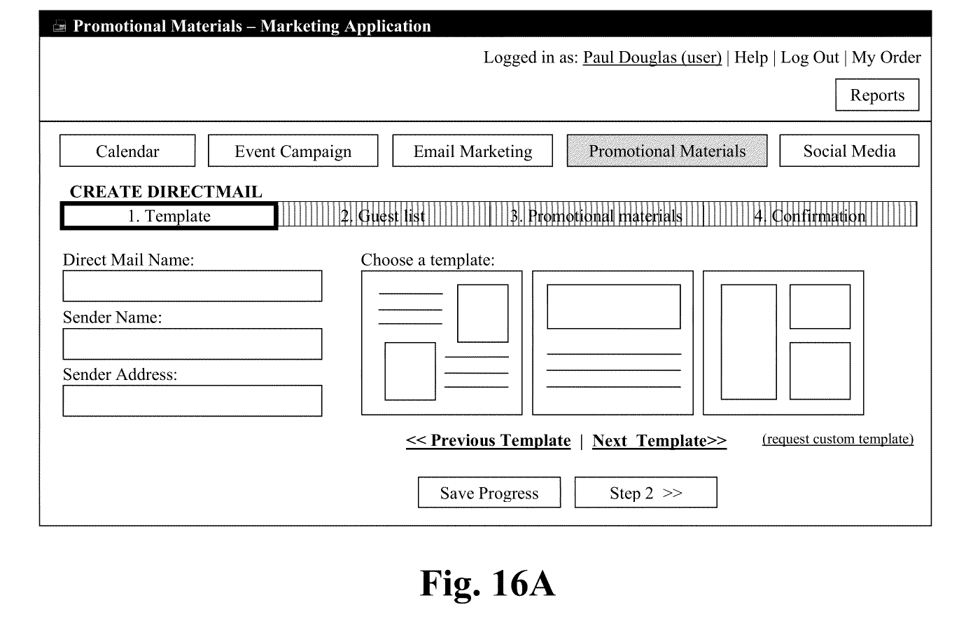

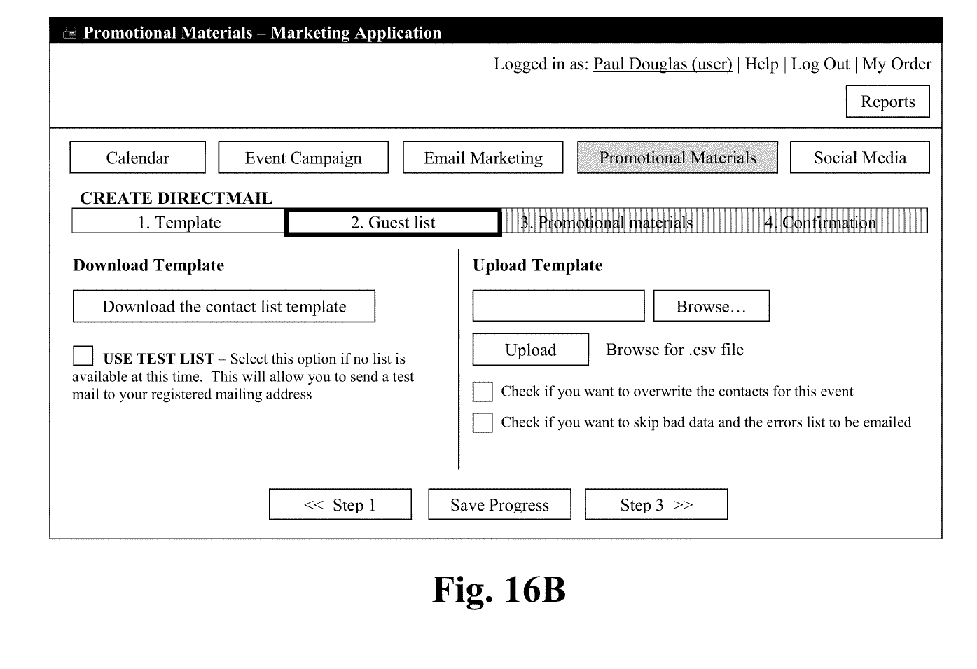

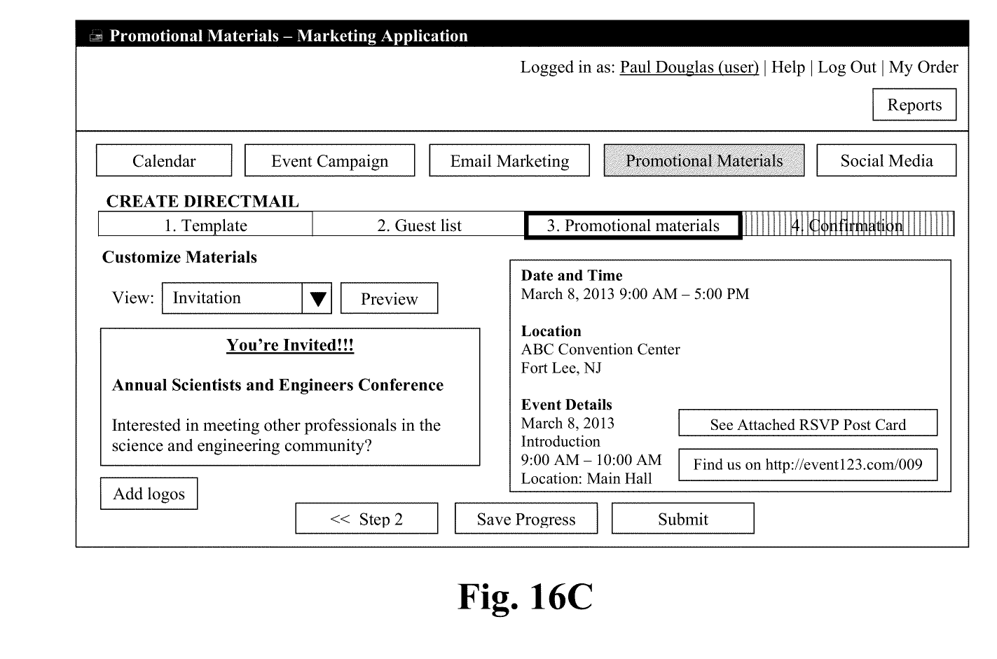

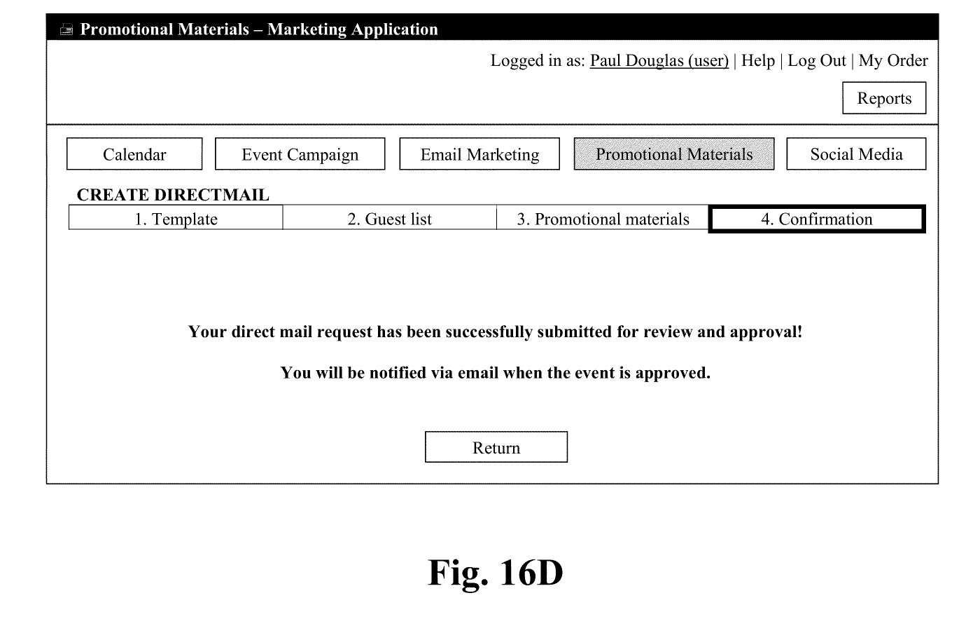

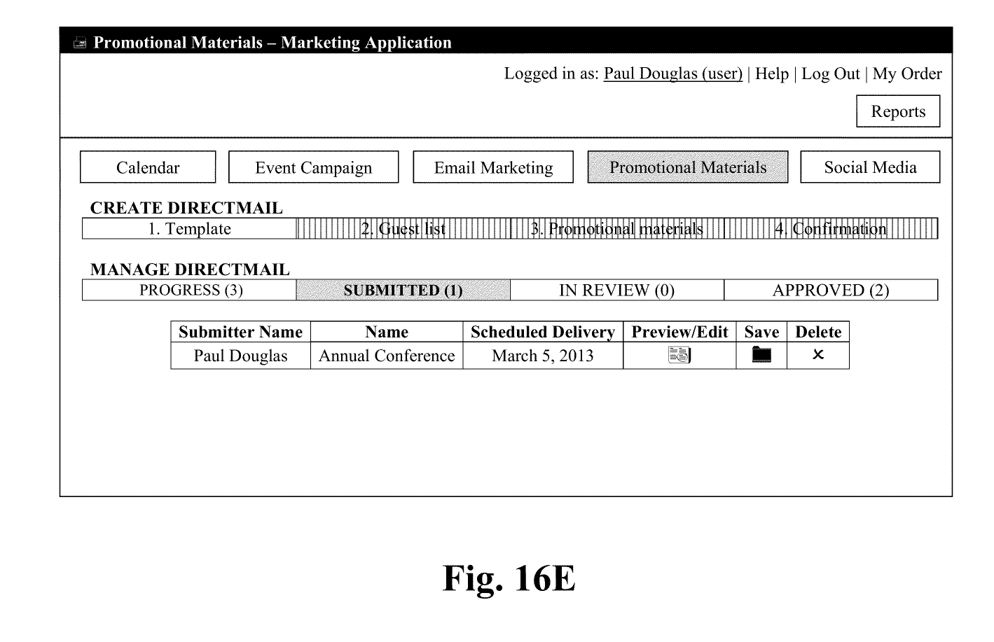

FIG. 15 shows a direct mail marketing user interface (Directmails View in FIG. 2D), which is displayed to the user when the user activates the “promotional materials” button at the top of the screen. In the example of FIG. 15, a list of the direct mail campaigns that are approved are displayed in a list view format. When the user clicks on the “template” button under “create direct mail”, a GUI shown in FIG. 16A is displayed to the user.

With reference to FIGS. 16A-16E, a GUI for a new direct mail campaign, according to an exemplary embodiment, is described.

FIG. 16A shows an example of a direct mail marketing creation GUI, according to an exemplary embodiment. As shown in FIG. 16A, the user can specify event-specific details and specify a template for the direct mail campaign.

When the user activates the “step 2>>” button, a guest list access GUI may be displayed to the user, as shown in FIG. 16B. In the example of FIG. 16B, the user may download the existing guest list, download a test list if no such is existing, or upload a guest list which includes the addresses (e.g. mailing addresses) of the guests to be invited to the marketing event.

When the user activates the “step 3>>” button, a GUI for customizing materials for the direct mail campaign is displayed to the user, as shown in FIG. 16C. The GUI allows the user to customize information included in the various marketing materials (e.g. invitation, save the date, reminder, thank-you note, etc.) for the marketing event.

Once the user activates the “submit” button, a confirmation screen is displayed to the user, as shown in FIG. 16D, indicating that the direct mail campaign has been submitted for approval by an event administrator.

As shown in FIG. 16E, the newly created direct mail campaign is now listed under the “submitted” section of the event selection GUI 103a-1.

The steps for creating a new direct mail campaign (e.g. as illustrated in FIGS. 16A-16E) are not limited to those discussed in the present disclosure, and one or more of the steps involved in creating the new direct mail campaign may be made optional, and one or more steps may be added in addition to the steps discussed herein.

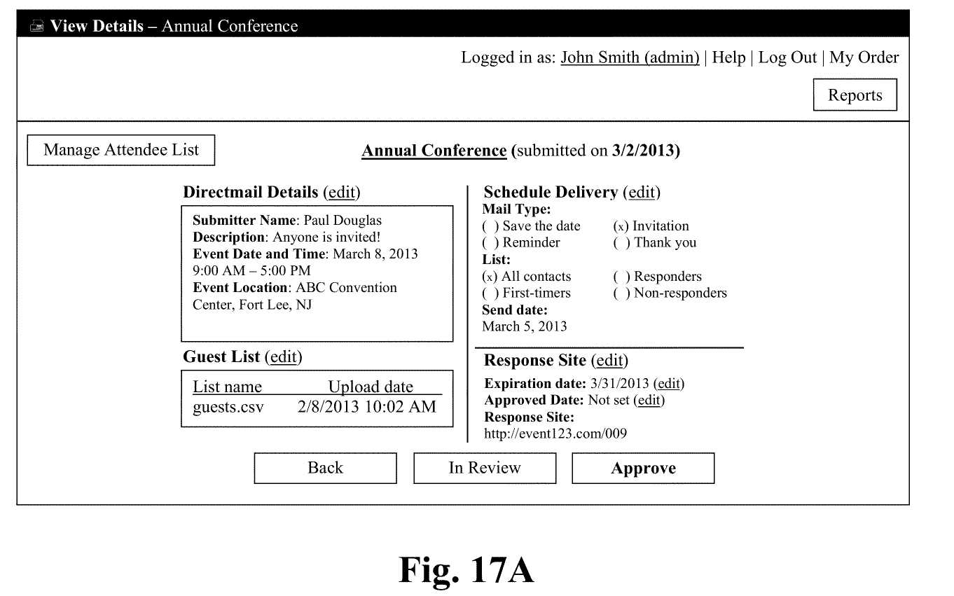

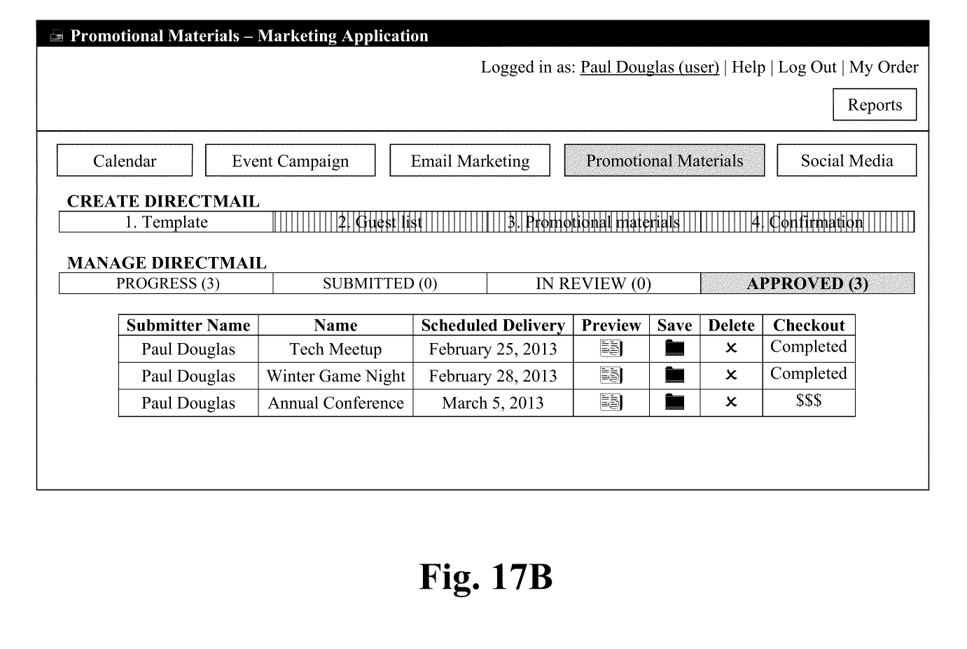

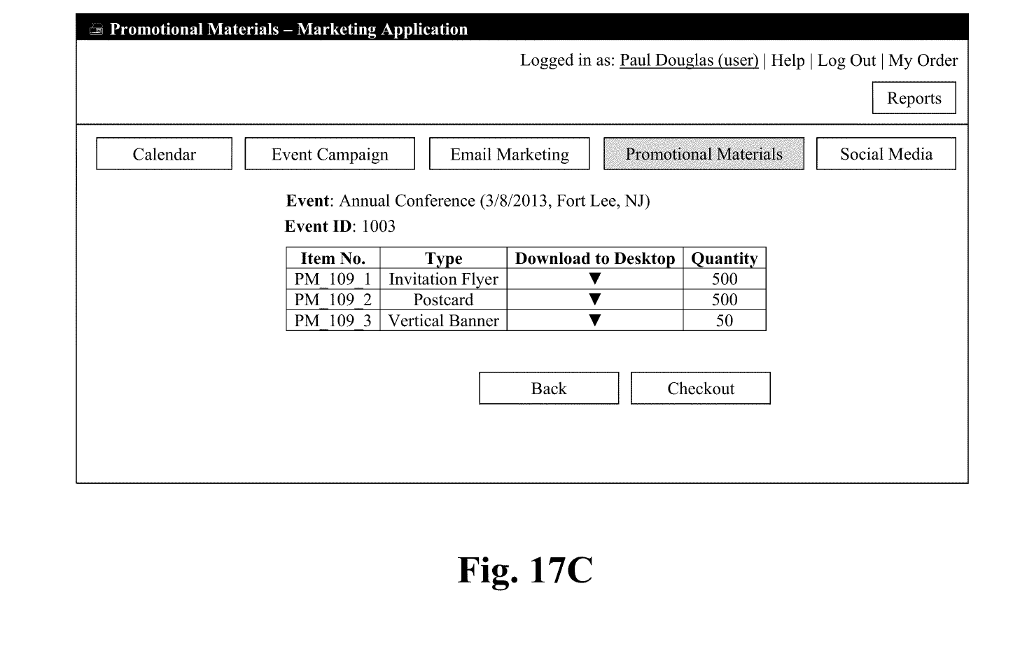

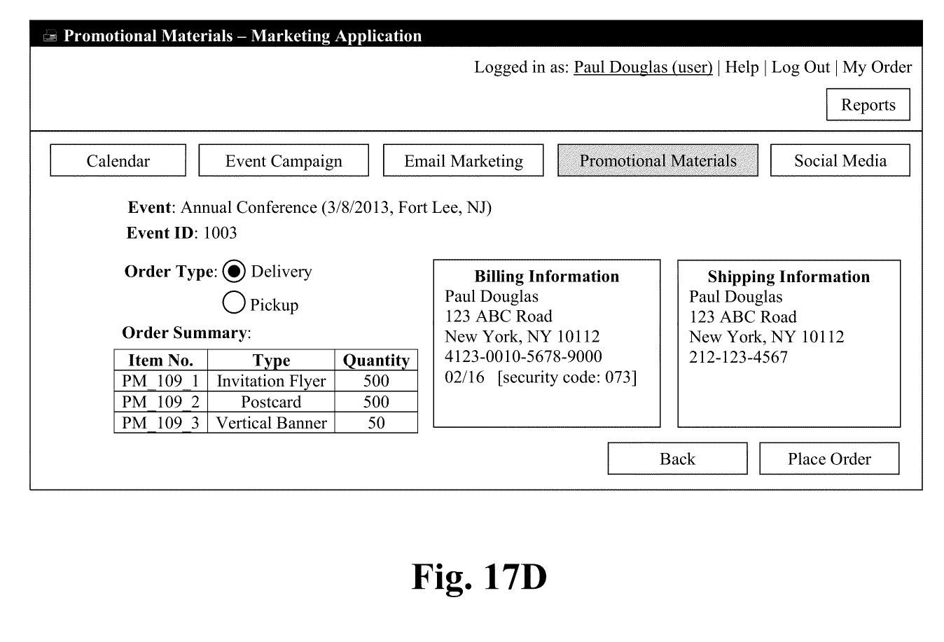

With reference to FIG. 17A, the GUI for displaying the details of an existing direct mail campaign, according to an exemplary embodiment, is described.

In FIG. 17A, the details of the newly submitted direct mail campaign are shown, for example, when the user activates the “preview/edit” button from the screen shown in FIG. 16E. In the example of FIG. 17A, the logged-in user is an administrator, so the user has the option of indicating that the submitted marketing event is now in review (e.g. by activating the “in review” button at the bottom of the screen) and approving the submitted marketing event (e.g. by activating the “approve” button). In the example of FIG. 17A, the direct mails are already scheduled to be sent out (e.g. Mar. 5, 2013). However, in another exemplary embodiment, the scheduling of the direct mails may take place only after the administrator has started reviewing or has approved the direct mail campaign.

Once the administrator approves the direct mail campaign, the approved direct mail campaign is displayed under the “approved” direct mail campaigns, as shown in FIG. 17B. In the example of FIG. 17B, the “$$$” sign indicates that the corresponding direct mail campaign is ready for checkout. When the user clicks on the “$$$” sign, a checkout window such as shown in FIG. 17C is displayed to the user. In the checkout window of FIG. 17C, the user may download an electronic copy of the customized materials (e.g. invitation flyer, postcard and vertical banner) to his or her desktop, and specify the quantity that he or she wishes to order. When the user activates the “checkout” button, the user is displayed another checkout window where the user may indicate whether he or she wishes to personally pick up the customized materials or have the customized materials delivered. The user may further be prompted to provide billing and/or shipping information necessary to place the order. When the user activates the “place order” button, the checkout process is completed.

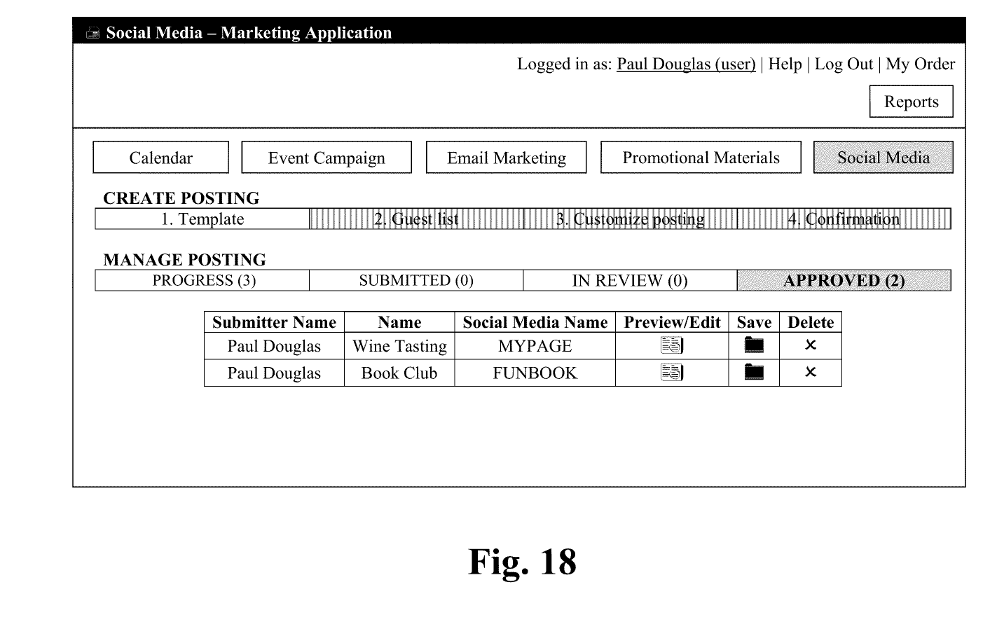

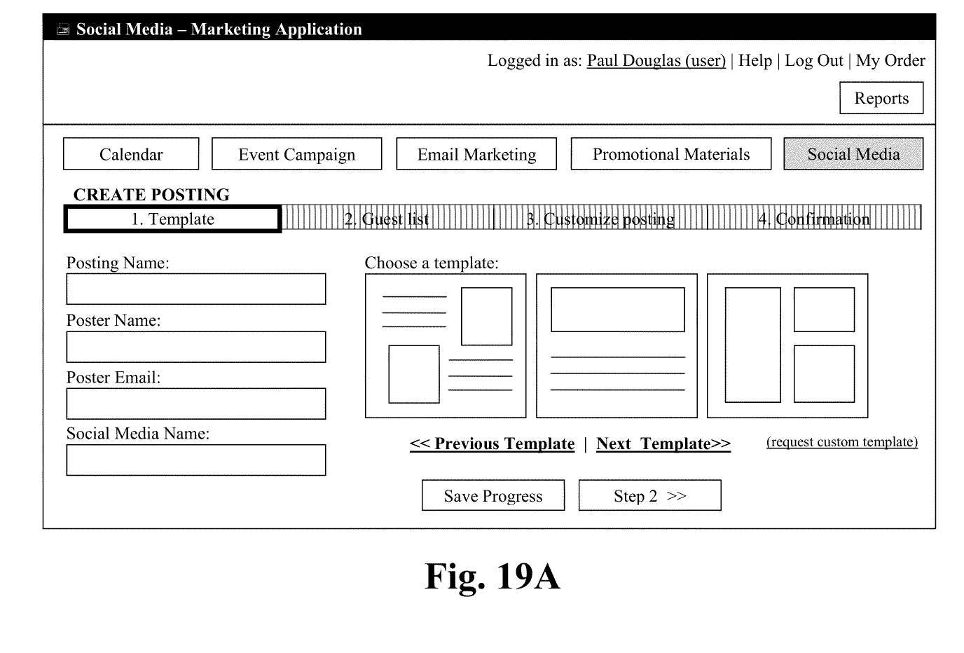

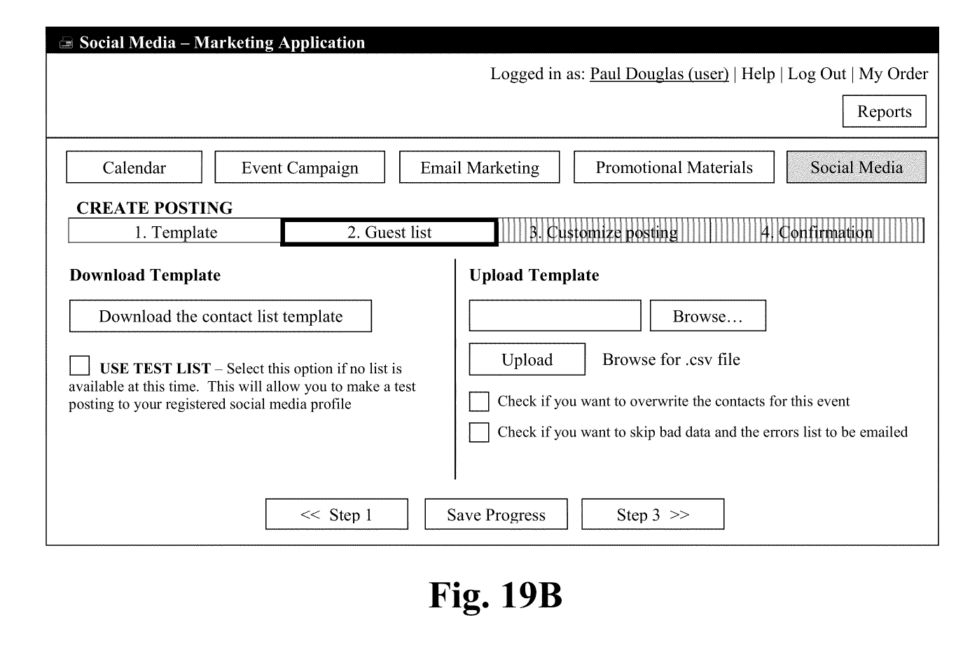

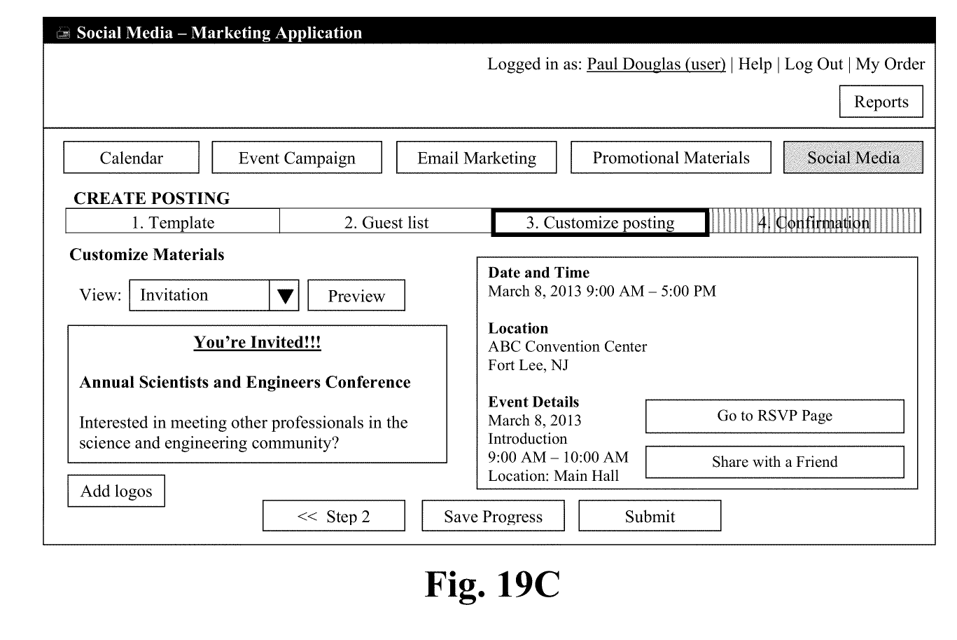

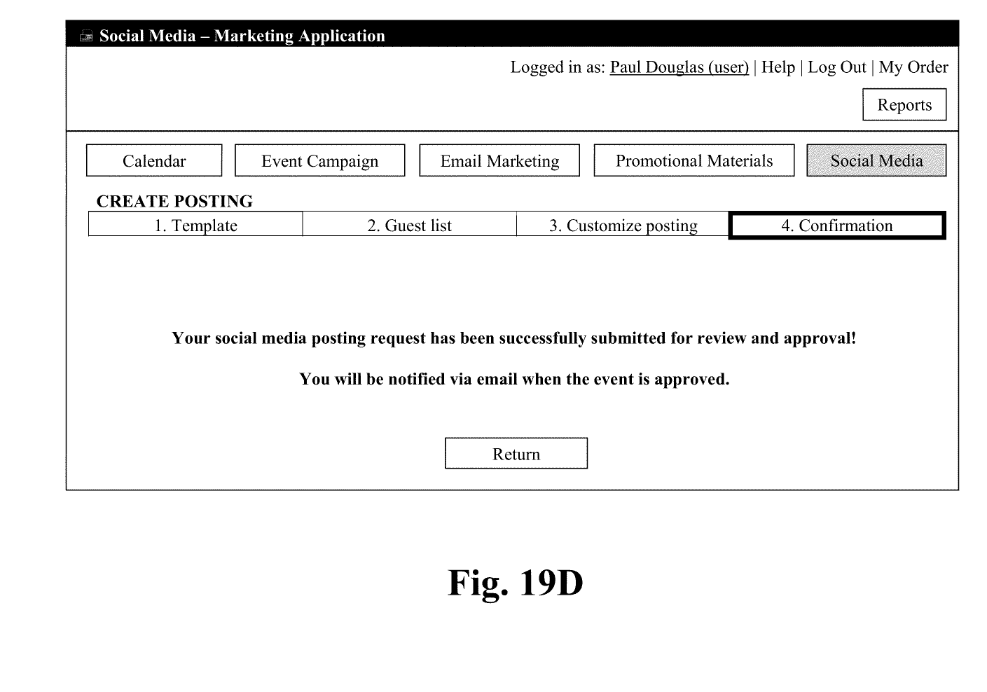

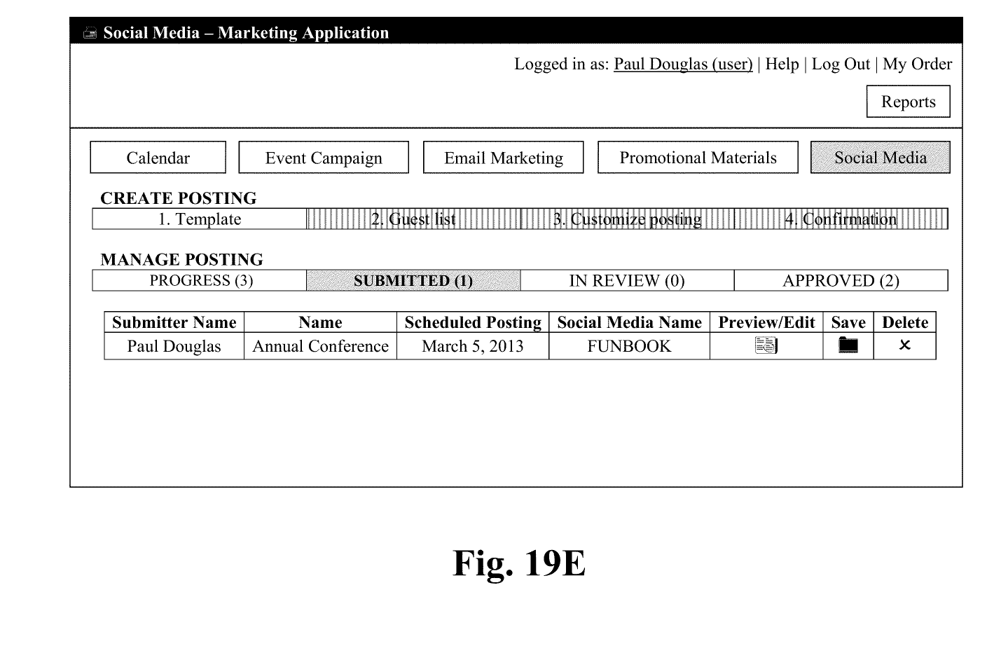

FIG. 18 shows a social media marketing user interface (Socialmedias View in FIG. 2E), which is displayed to the user when the user activates the “social media” button at the top of the screen. In the example of FIG. 18, the social media posting campaigns that are approved are displayed in a list view format. When the user clicks on the “template” button under “create posting”, a GUI shown in FIG. 19A is displayed to the user.

With reference to FIGS. 19A-19E, the GUI for creating a new social media posting campaign for a marketing event, according to an exemplary embodiment, is described.

FIG. 19A shows an example of a social media marketing creation GUI, according to an exemplary embodiment. As shown in FIG. 19A, the user can specify event-specific details and specify a template for the social media posting campaign.

When the user activates the “step 2>>” button, a guest list access GUI may be displayed to the user, as shown in FIG. 19B. In the example of FIG. 19B, the user may download the existing guest list, download a test list if no such is existing, or upload a guest list which includes the addresses (e.g. social media profiles) of the guests to be invited to the marketing event.

When the user activates the “step 3>>” button, a GUI for customizing materials for the social media posting campaign is displayed to the user, as shown in FIG. 19C.

The GUI allows the user to customize information included in the various marketing materials (e.g. invitation, save the date, reminder, thank-you note, etc.) for the marketing event.

Once the user activates the “submit” button, a confirmation screen is displayed to the user, as shown in FIG. 19D, indicating that the social media posting campaign has been submitted for approval by an event administrator.

As shown in FIG. 19E, the newly created social media posting campaign is now listed under the “submitted” section of the event selection GUI 103a-1.

The steps for creating a new social media posting campaign (e.g. as illustrated in FIGS. 19A-19E) are not limited to those discussed in the present disclosure, and one or more of the steps involved in creating the new social media posting campaign may be made optional, and one or more steps may be added in addition to the steps discussed herein.

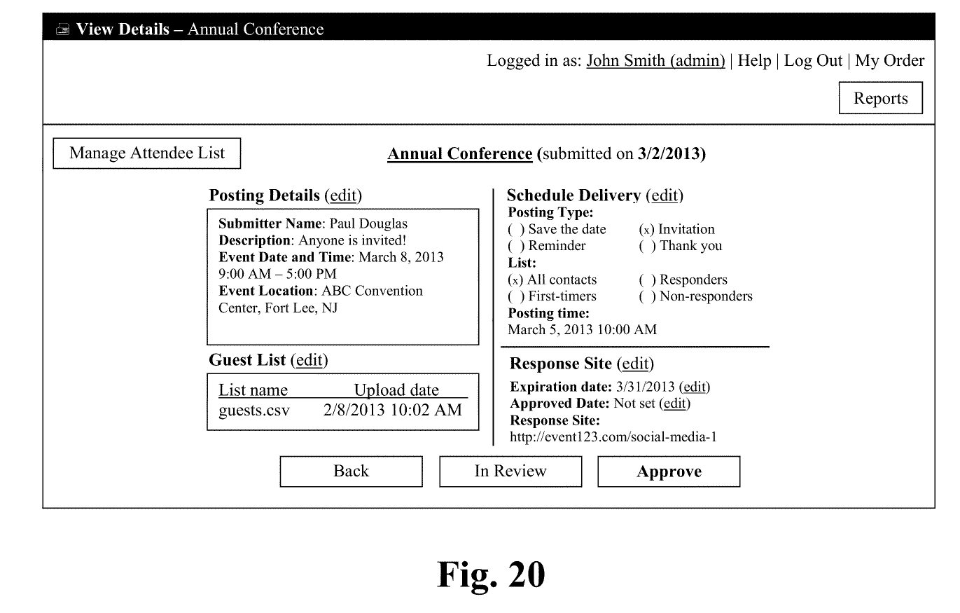

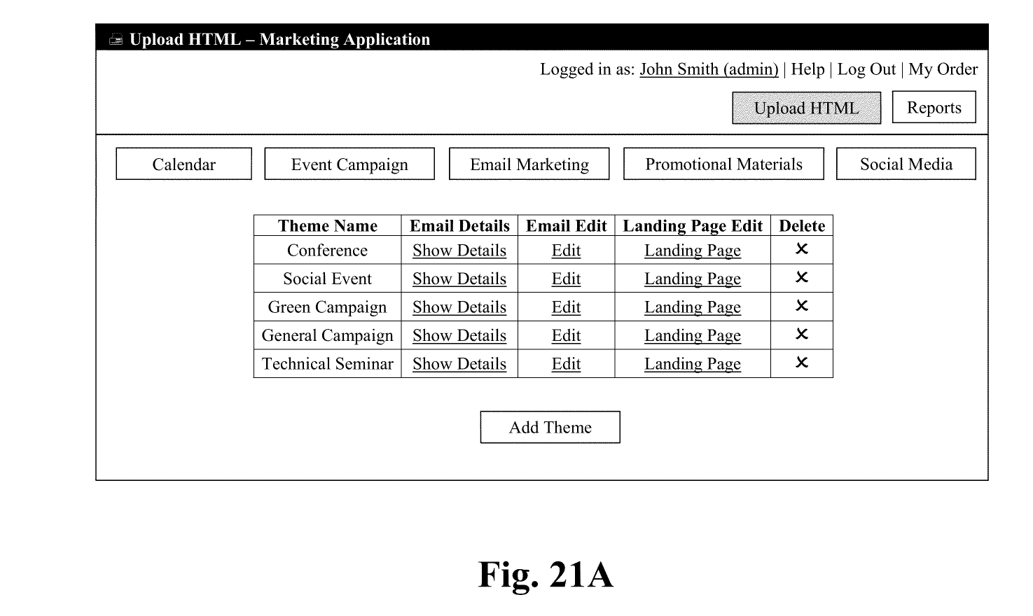

With reference to FIG. 20, the GUI for displaying the details of an existing social media posting campaign, according to an exemplary embodiment, is described.

In FIG. 20, the details of the newly submitted social media posting campaign are shown, for example, when the user activates the “preview/edit” button from the screen shown in FIG. 19E. In the example of FIG. 20, the logged-in user is an administrator, so the user has the option of indicating that the submitted marketing event is now in review (e.g. by activating the “in review” button at the bottom of the screen) and approving the submitted marketing event (e.g. by activating the “approve” button). In the example of FIG. 20, the social media postings are already scheduled to be posted (e.g. Mar. 5, 2013, 10:00 AM). However, in another exemplary embodiment, the scheduling of the social media postings may take place only after the administrator has started reviewing or has approved the social media posting campaign.

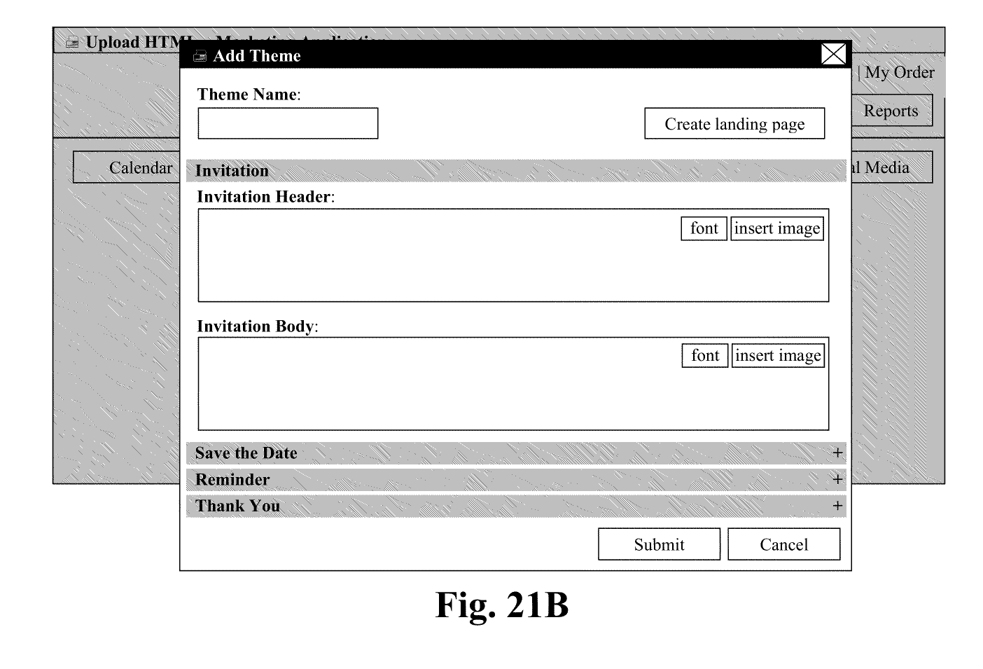

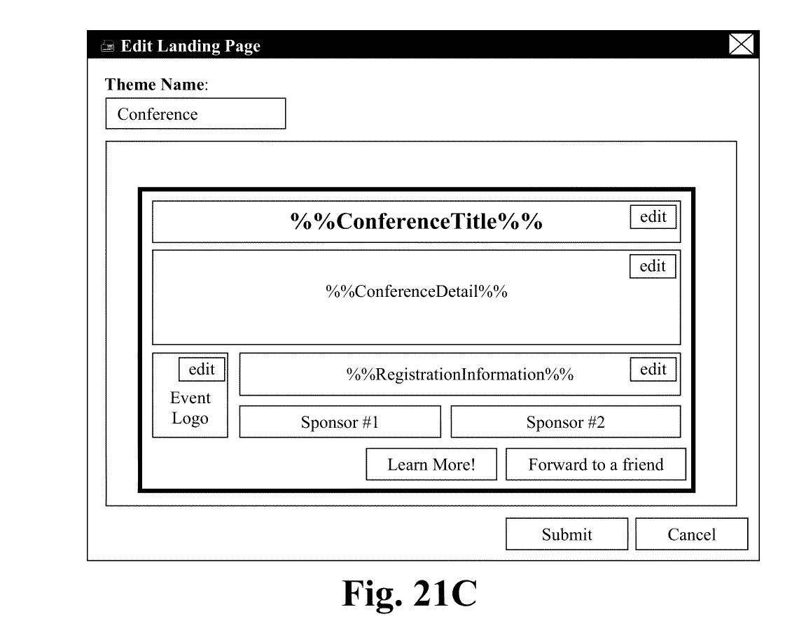

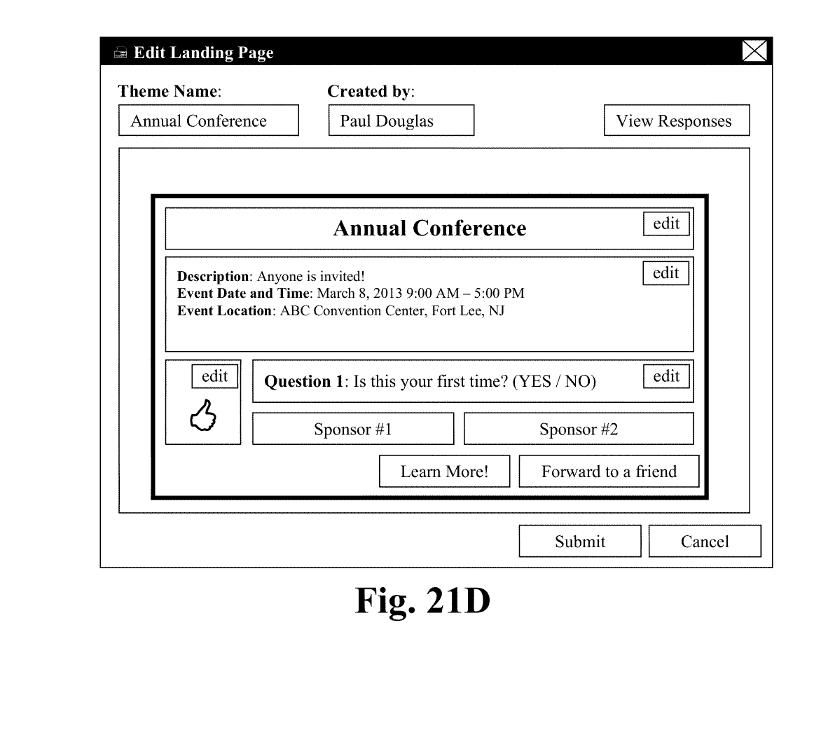

With reference to FIG. 21A-21D, the GUI for managing the themes, templates and landing pages, according to an exemplary embodiment, is described.

FIG. 21A shows a list of themes available to be used for creating a new marketing event. The user may add a new theme by activating the “add theme” button at the bottom of the screen, as shown in FIG. 21B. Further, when the “landing page” link shown in the screen of FIG. 21A is activated, a GUI for editing the landing page corresponding to the link is displayed to the user, as shown in FIG. 21C. In another exemplary embodiment, the page for editing the landing page for an already-created marketing event may be as shown in FIG. 21D, which has all the event-specific details filled in. In addition, when the user activates the “view responses” button, a screen similar to that shown in FIG. 11A may be displayed to the user to indicate the attendees who have responded via the landing page.

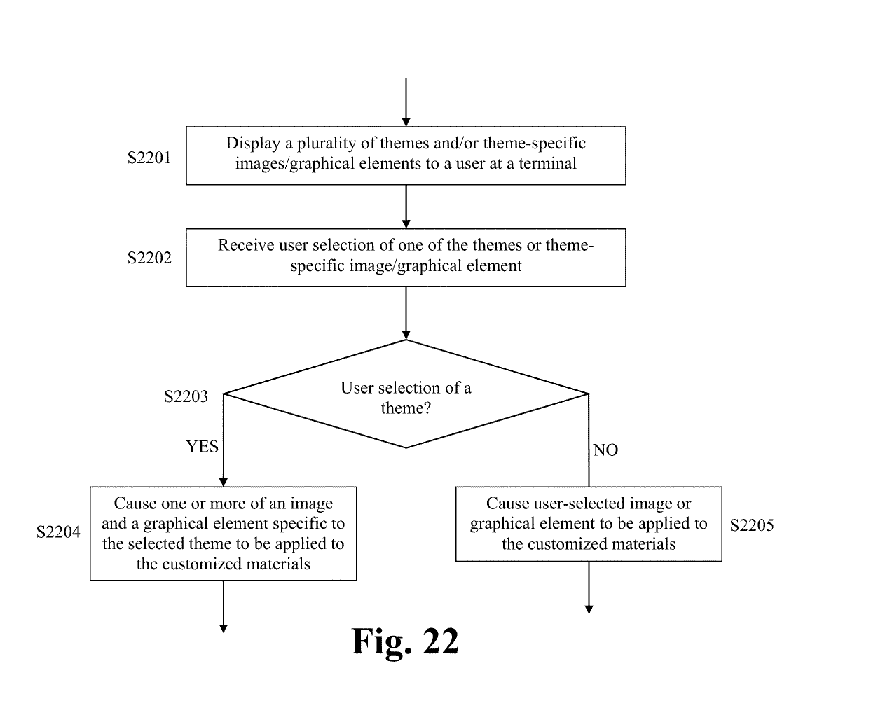

With reference to FIG. 22, a flow chart of a method for customizing campaign materials for a particular marketing event, according to an exemplary embodiment, is described.

In S2201, a plurality of themes and/or theme-specific images/graphical elements is displayed to the user at the terminal. When the user selects one of the themes or the theme-specific images/graphical elements, the user selection is received (step S2202), and it is checked whether the user has selected a theme (step S2203). In a case that the user has selected a theme (YES, step S2203), the one or more images and graphical elements specific to the selected theme are applied to the customized materials for the particular marketing event (step S2204). On the other hand, in a case that the user has selected an image or a graphical element (NO, step S2203), the user-selected image or graphical element is applied to the customized materials for the particular marketing event (step S2205).

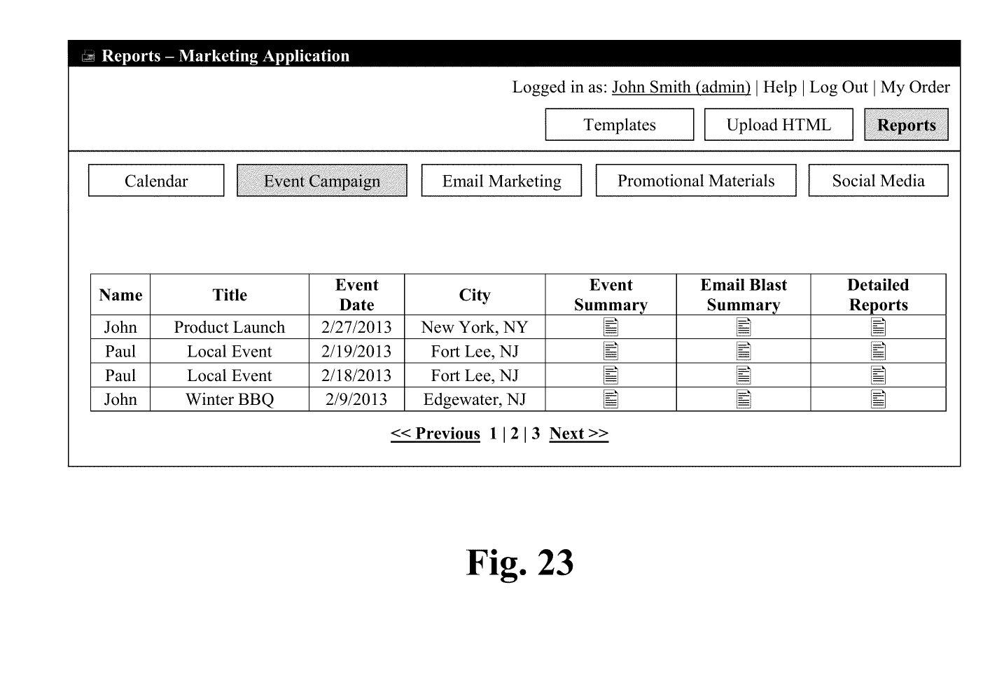

With reference to FIG. 23, a reporting functionality of a marketing connection application, according to an exemplary embodiment, is described.

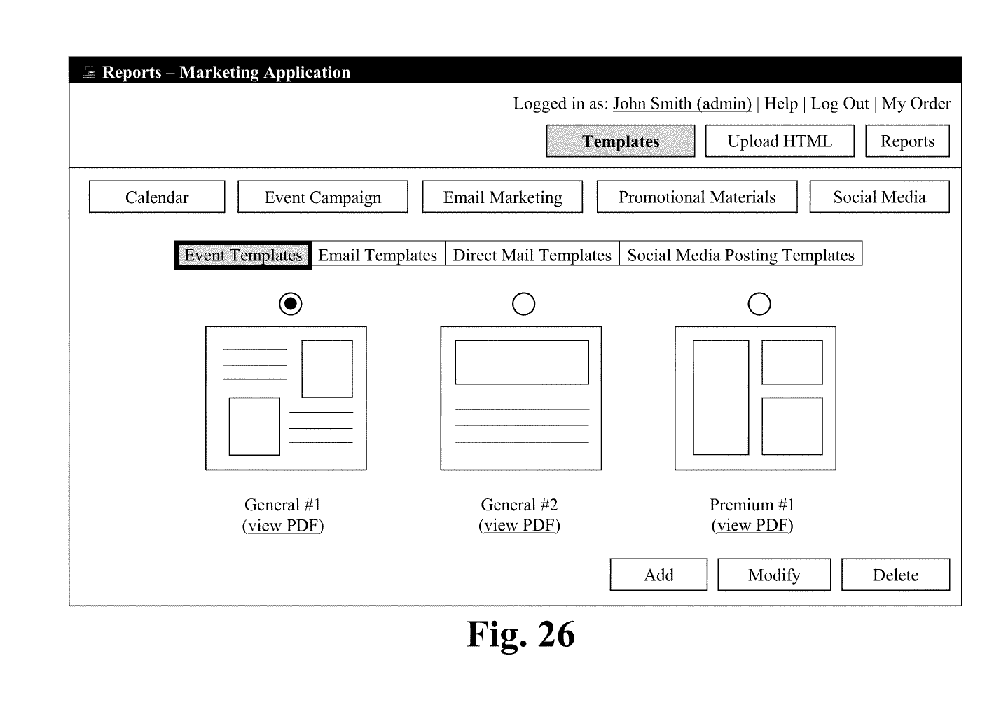

When the user activates the “reports” button at the top of the screen, a list of approved campaigns is displayed to the user, as shown in FIG. 23. The GUI window of FIG. 23 also includes the “templates” button, which is further described infra with reference to FIG. 26.

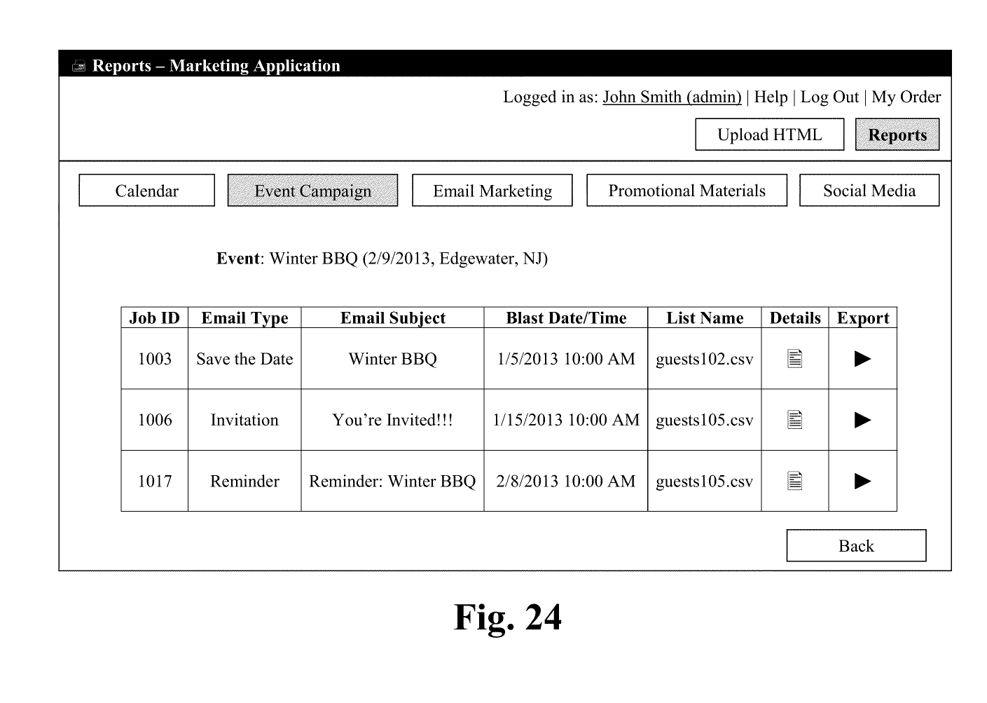

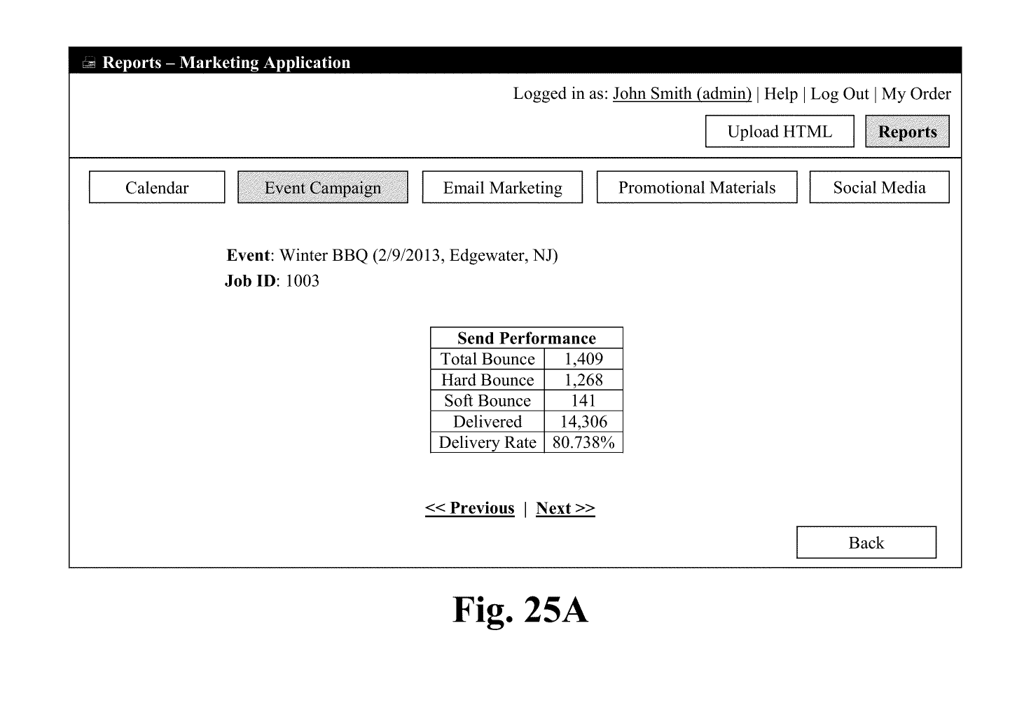

When the user selects the “email blast summary” button corresponding to one of the approved campaigns from the list of campaigns, a list of email blasts is displayed to the user, as shown in FIG. 24. Each entry indicates the job ID of the email blast, email type, email subject, blast date/time, name of the guest list (e.g. contact list), details of the email blast, and a button for exporting the email blast.

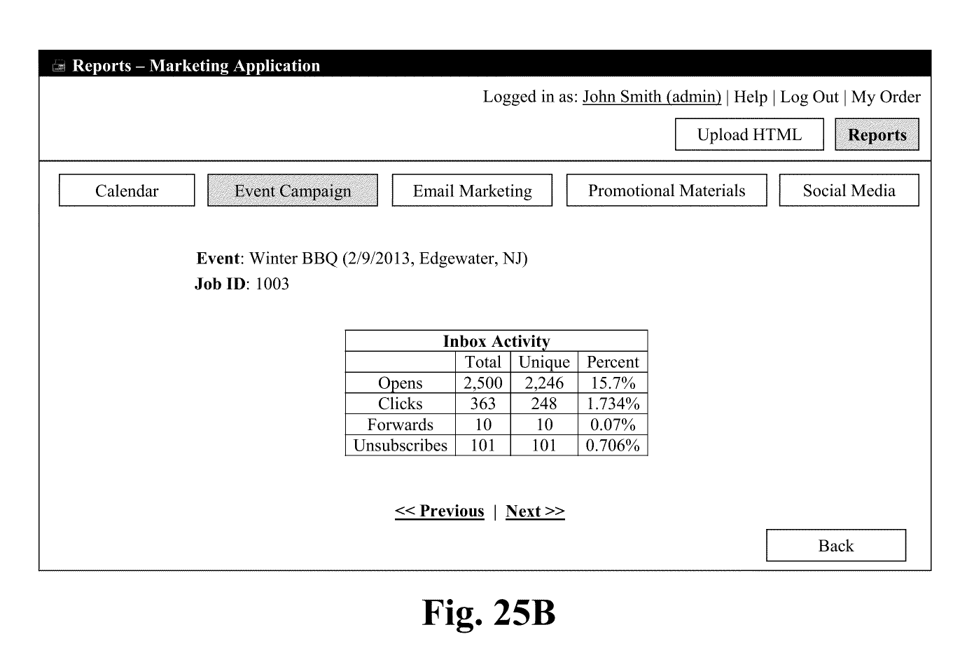

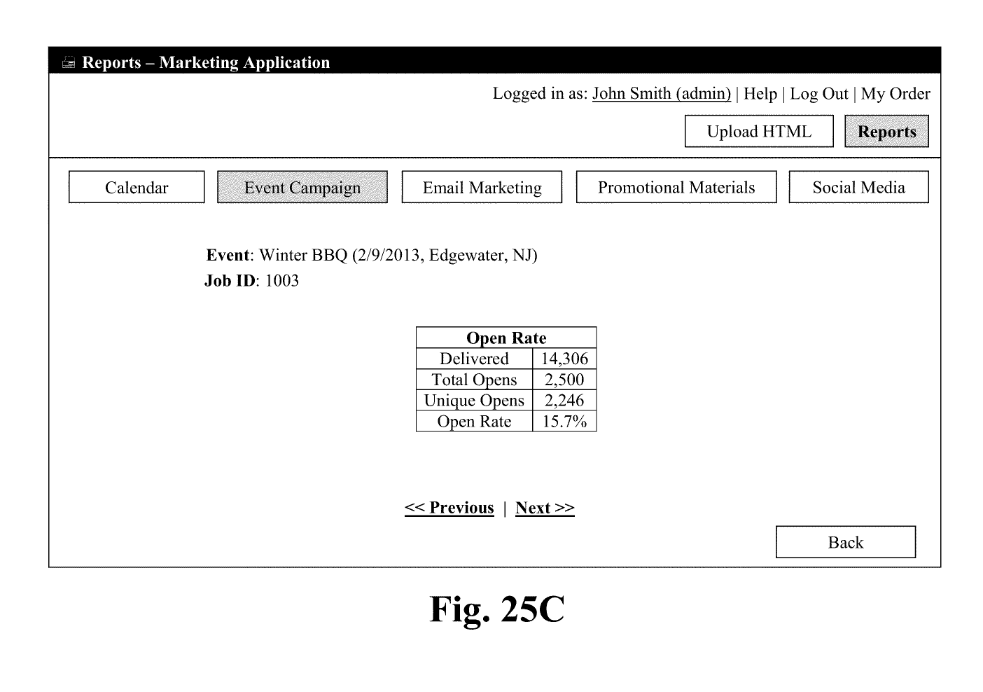

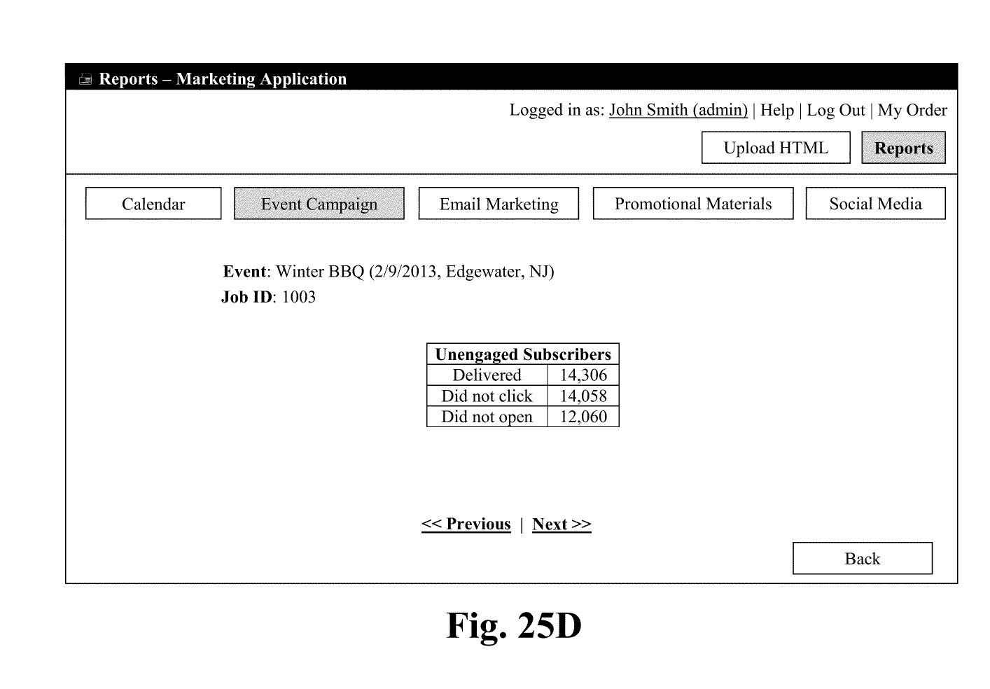

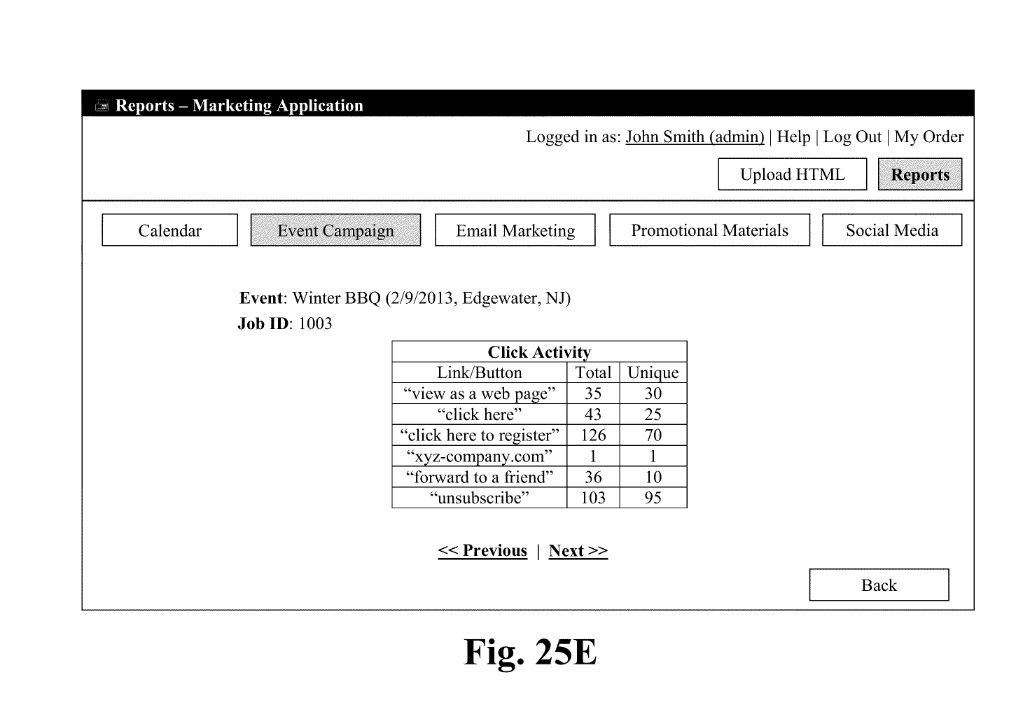

When the user selects the “details” button corresponding to one of the email blasts, further details of the selected email blast is displayed to the user as shown in FIGS. 25A-25E.

With reference to FIG. 26, a GUI window for allowing the user to manage the various templates stored by the marketing connection application, according to an exemplary embodiment, is described.

When the user activates the “templates” button at the top of the screen, a plurality of templates are displayed to the user. In the example of FIG. 26, the user has selected the “event templates” button, causing all the event templates to be listed. In the same manner, the email templates, direct mail templates, and social media posting templates may be viewed. The user can select a template from the list of templates displayed to the user, and view the template as a PDF. The user may also add a new template, or modify or delete the selected template, by activating the “add”, “edit” and “delete” buttons, respectively.

In the aforementioned marketing campaign management system, users can conveniently create a marketing campaign or event and customized any materials (electronic or physical) needed for the campaign event (e.g. emails and/or promotional materials sent to targeted audience or invitee(s), or social media postings posted on social media sites to reach the guests, invitees or other audience).

The aforementioned specific embodiments are illustrative, and many variations can be introduced on these embodiments without departing from the spirit of the disclosure or from the scope of the appended claims.

For example, elements and/or features of different examples and illustrative embodiments may be combined with each other and/or substituted for each other within the scope of this disclosure and appended claims.

Further, it should be appreciated that the description above of the invention generically uses the term “event” to explain a typical workflow, although the workflow can often be centered on a marketing campaign that ultimately one event or plural events. Accordingly, an event campaign can lead to development to development of materials for multiple events, that can be utilized in one campaign, and even reused or adapted for additional campaigns or events.

What is claimed is:

1. A marketing connection application for marketing campaign and event development and management, the marketing connection application including one or more programs of computer-executable instructions embodied in a non-transitory computer-readable medium and executable by a processing unit of a terminal apparatus, to configure the terminal apparatus to include:
an event selection GUI (graphical user interface) interface providing one or more GUI elements for user selection of a marketing campaign or event;
an event campaign GUI interface to provide to the user:
an event creation and development part through which the user specifies a marketing object to be created for the selected marketing campaign or event, and specifies details specific to the selected marketing campaign or event to populate the marketing object for the selected marketing campaign or event;
a guest list access part maintaining a list of guests and invitees for the marketing event, and providing the list, upon request by the user, for user edit of the list of guests and invitees;
a customizing materials GUI interface providing GUI parts for user selection of a marketing template and populating the selected marketing template with event information maintained in the marketing object, for user selection of already-generated materials, for user modification of the populated marketing template and/or already-generated materials to form customized marketing materials for the selected marketing event, and for causing the customized marketing materials to be maintained in association with the marketing object for the selected marketing event;
a review event information GUI interface providing GUI parts for user selection of one or more of the event-specific details, customized marketing materials and other associated information, for the marketing event, for editing; and
an event submission part that submits the marketing object, associated details, customized marketing materials and other associated information, for the marketing event, for approval by an event administrator.

2. The marketing connection application of claim 1, wherein the event selection GUI interface provides the GUI elements in a calendar view for user selection of a marketing event.

3. The marketing connection application of claim 1, wherein
the marketing connection application provides a login interface on the terminal apparatus operated by the user, and
after user authentication based on user credentials entered by the user through the login interface, the GUI elements provided in the calendar view are selected by the event selection GUI interface based on the authenticated user credentials.

4. The marketing connection application of claim 1, wherein
the customizing materials GUI interface includes a theme selection part for user selection of a theme or one or more of a theme-specific image and a theme-specific graphical element, and wherein
in a case that the user selects a theme, the theme selection part causes one or more of an image and a graphical element specific to the selected theme to be applied to the customized materials, and
in a case that the user selects a theme-specific image or theme-specific graphical element, the theme selection part causes the user-selected theme-specific image or graphical element to be applied to the customized materials.

5. The marketing connection application of claim 1, wherein
the customizing materials GUI interface includes a preview part that permits the user to request preview of a specified item amongst the customized marketing materials.

6. The marketing connection application of claim 1, wherein
the event creation and development part of the event campaign GUI interface provides one or more event templates for user selection, and
in a case that the user selects an event template, the event creation and development part populates the event template with the user-specified event-specific details specific to the marketing event, and generates the marketing object based on the populated event template.

7. The marketing connection application of claim 1, wherein the event campaign GUI interface further provides
an event agenda access part to create and maintain an event agenda for the selected marketing event, and provide the event agenda, upon request by the user, for modification.

8. The marketing connection application of claim 1, wherein the event campaign GUI interface further provides
a registration customization interface through which the user customizes information fields of a registration GUI interface to be provided at a registration page.

9. The marketing connection application of claim 1, wherein the marketing connection application further configures the terminal apparatus to include:
an e-mail marketing interface for compiling an event marketing e-mail, including selecting a marketing e-mail type or template, formulating a distribution list, and one or more of the customized materials to be included in the event marketing e-mail for the marketing event, and scheduling e-mail transmission date-and-time.

10. The marketing connection application of claim 9, wherein
the event marketing e-mail is automatically generated by the e-mail marketing interface based on the selected marketing e-mail type or template and the selected materials,
the e-mail marketing interface includes a preview part that permits the user to request preview of the event marketing e-mail, and
the e-mail marketing interface permits the user to retrieve and modify the event marketing e-mail, before the scheduled transmission date-and-time.

11. The marketing connection application of claim 9, wherein
the e-mail marketing interface includes a response review interface for providing, upon user request, a summary of responses to the event marketing e-mail, and wherein
the response review interface includes a filter for filtering the response summary according to one or more filter criteria selected from a group including a date range, an alphabetized name range, a company name, an alphabetized e-mail address range, and an e-mail address domain.

12. The marketing connection application of claim 1, wherein the marketing connection application further configures the terminal apparatus to include:
a landing page development interface to develop an event landing page, based on at least a selected landing page template and one or more selected items from amongst the customized materials, and to further customize content on the event landing page, and wherein
the landing page development interface includes a registration customization interface through which the user customizes information fields of a registration GUI interface to be provided through the event landing page.

13. The marketing connection application of claim 12, wherein
the landing page development interface further includes a response review interface for providing, upon user request, a summary of responses received through the event landing page, and
the response review interface includes a filter for filtering the response summary according to one or more filter criteria selected from a group including a date range, an alphabetized name range, a company name, an alphabetized e-mail address range, and an e-mail address domain.

14. The marketing connection application of claim 1, wherein the marketing connection application further configures the terminal apparatus to include:
a social media interface to develop a posting, based on at least a selected social media template and one or more selected items from amongst the customized materials, and to further customize content on the social media posting, and wherein
the social media interface includes a registration customization interface through which the user customizes information fields of a registration GUI interface to be provided through the social media posting.

15. The marketing connection application of claim 14, wherein
the social media interface further includes a response review interface for providing, upon user request, a summary of responses received through the social media posting, and
the response review interface includes a filter for filtering the response summary according to one or more filter criteria selected from a group including a date range, an alphabetized name range, a company name, an alphabetized e-mail address range, and an e-mail address domain.

16. The marketing connection application of claim 1, wherein the marketing connection application further configures the terminal apparatus to include:
a response review interface for providing, upon user request, a summary of responses to an invitation to the marketing event, and wherein
the response review interface includes a filter for filtering the response summary according to one or more filter criteria selected from a group including a date range, an alphabetized name range, a company name, an alphabetized e-mail address range, and an e-mail address domain.

17. The marketing connection application of claim 1, wherein a web service providing apparatus provides the marketing connection application through a network to the terminal apparatus, and receives from the terminal the event-specific details, customized marketing materials and other associated event-specific information, associated with the marketing object, for the marketing event, and forwards to a marketing database the event-specific details, customized marketing materials and other associated event-specific information, associated with the marketing object, for the marketing event.

18. The marketing connection application of claim 1, wherein the marketing connection application configures the terminal apparatus to be a marketing connection service client, to communicate through a network with a marketing connection service providing apparatus,
the event selection GUI interface and the event campaign GUI interface are provided by the marketing connection service client on the terminal apparatus operated by the user,
the marketing connection service client on the terminal apparatus operated by the user communicates the event-specific details, customized marketing materials and other associated event-specific information, associated with the marketing object, for the marketing event, to the marketing connection service providing apparatus, and
the marketing connection service providing apparatus causes the event-specific details, customized marketing materials and other associated event-specific information, associated with the marketing object, for the marketing event, to be stored in a marketing database.
